(19) United States
(12) Patent Application Publication
(10) Pub. No.: US 2014/0185133 A1
(43) Pub. Date: Jul. 3, 2014

(54) CONTROLLED TRANSMISSION AND REFLECTION IN WINDOWS

(71) Applicant: Hanoch SHALIT, Nicosia (CY)

(72) Inventor: Hanoch SHALIT, Nicosia (CY)

(21) Appl. No.: 14/145,946

(22) Filed: Jan. 1, 2014

Related U.S. Application Data
(60) Provisional application No. 61/748,088, filed on Jan. 1, 2013.
(60) Provisional application No. 61/793,774, filed on Mar. 15, 2013.
(60) Provisional application No. 61/827,769, filed on May 28, 2013.
(60) Provisional application No. 61/893,969, filed on Oct. 22, 2013.

(51) Int. Cl. G02B 5/20

(52) U.S. Cl. CPC G02B 5/201
USPC 359/350; 359/885

(57) ABSTRACT

A variable transmission medium having a plurality of patterned surfaces disposed on light-transmissive material and separated by an inter-surface gap enabling regulation of light transmission by a change in angle of incident or viewing.

### FIELD

The present invention relates to variable light transmission through a medium, and specifically, relates to light transmission through the medium as a function of an angle of light incidence on the medium.

### BACKGROUND

Light transmission through transparent materials or the lack of transmission through opaque materials may produce unwanted side effects.

For example, near complete transmission through windows may be deemed excessive when uncomfortably bright to a viewer or in settings where privacy is needed.

On the other hand, total light blockage of light by an automotive visor often results in a loss of road visibility.

Therefore, there is a need for a variable light-transmissive medium capable of both enhancing attenuation in transmission-oriented applications and also enhancing transmission in attenuation-oriented applications.

These shortcomings have been addressed with systems providing either static or dynamic light filtration; however, both suffer from various shortcomings.

The light transmission properties of static, partial-light-transmission systems, such as a fixed transmission filter, are defined during manufacture and therefore lack the flexibility required in variable lighting setting, whereas dynamic-light-transmission systems, like those found in smart glass technology, require electrical circuitry and energy to modify the optical properties to provide variable light transmission. Furthermore, smart glass requires sophisticated production methods and equipment, and therefore, acquisition costs may be prohibitive.

Therefore, an economical, non-electrical, variable light transmission system is needed.

### BRIEF DESCRIPTION OF THE DRAWINGS

The subject matter disclosed may best be understood by reference to the following detailed description when read with the accompanying drawings in which:

FIG. 1 is a schematic front view of a light-transmissive substrate depicting a patterned surface of attenuating and non-attenuating regions for a variable light transmission medium, according to an embodiment of the invention;

FIG. 1A is a schematic side view of the substrate of FIG. 1 depicting opposing, parallel patterned surfaces of attenuating and non-attenuating regions, according to an embodiment;

FIG. 1B is a schematic, side view of a single substrate having parallel, patterned surfaces of partially-attenuating and non-attenuating regions, according to an embodiment;

FIG. 2 is a front, schematic, view of a light-transmissive substrate having a patterned surface in which the area of the non-attenuating regions varies in accordance to its distance from an edge of the substrate; according to an embodiment of the invention;

FIG. 2A is a schematic, front view of a light-transmissive substrate having opposing, non-parallel patterned surfaces of attenuating and non-attenuating regions, according to an embodiment of the invention;

FIG. 3 is a schematic, side view of a double-substrate embodiment in which the, patterned surfaces of attenuating and non-attenuating regions are disposed on separate substrates, according to an embodiment of the invention;

FIGS. 3A-3C (The figures are 3, 3b,3c,3d there is no 3A) are schematic, side views of various double-substrate embodiments depicting various forms of an inter-surface gap between patterned surfaces;

FIG. 4 is a schematic, side view of a multiple-substrate embodiment having inter-surface gaps filled with gas or liquid, according to embodiments of the invention;

FIG. 5 is schematic, side views of a double-substrate embodiment of the variable, light-transmission medium disposed at light transmission and blockage orientations, respectively, according to an embodiment of the invention;

FIGS. 6 and 6A are schematic, side views of a multi-substrate embodiment of a variable transmission medium disposed in full and non-transmission states, according to an embodiment of the invention;

FIG. 7 is a schematic, side view of a double-substrate embodiment of a variable light-transmission medium depicting banding as a function of viewing distance, according to an embodiment of the invention;

FIG. 7A is a schematic, top view of a light-transmission medium configured to restrict the viewing angle of an electronic display device, according to an embodiment of the invention;

FIG. 8 is a schematic, side view of a pivotally mounted, double-substrate, variable light-transmission medium depicting light transmission in various orientations, according to an embodiment of the invention;

FIG. 9 is a schematic, side view of a pivotally mounted, single-substrate, variable transmission medium depicting light transmission in various orientations, according to an embodiment of the invention;

FIG. 10 is a schematic, side view of a pivotally mounted single-trapezoidal-substrate, variable transmission medium in various orientations, according to an embodiment of the invention;

FIGS. 11 and 11A are schematic, side views of a variable light-transmission medium implemented as a motorcycle helmet visor in full and reduced light transmission states, respectively, according to an embodiment of the invention;

FIG. 12 is a schematic view of a variable light-transmission medium implemented as a cap visor in maximum light transmission and glare reduction state, according to an embodiment of the invention;

FIGS. 13A and 13B are schematic views of a variable light-transmission medium implemented as a building visor configured to attenuate as function of sun position, in full and reduced light transmission states, respectively according to an embodiment of the invention;

FIG. 13C is a schematic view of the building visor of FIGS. 13A and 13B disposed in a position simultaneously allowing image light of the scenery to traverse the visor while reflecting heat and attenuating direct sunlight, according to an embodiment of the invention;

FIGS. 14 and 15 depict variable light-transmission medium implemented as a greenhouse roof having spectral-specific attenuating regions functional in accordance with daily and seasonal changes in the angle of incidence of sunlight; according to an embodiment of the invention;

FIGS. 15A and 15B are perspective views of seasonally-responsive, spectral-specific attenuating regions configured to provide seasonally responsive transmission based on the angle of incidence of direct sunlight as a function of seasonal trajectories, according to an embodiment of the invention;

FIG. 15C is a perspective view of time-responsive, spectral-specific attenuating regions configured to provide time responsive transmission, based on the angle of incidence of direct sunlight as a function of the daily trajectories, according to an embodiment of the invention;

FIG. 15D is schematic, perspective view of a motor vehicle equipped with a variable-transmission sunroof and back window, according to an embodiment;

FIG. 15E is schematic side-view of variable-transmission sunroof in a full-transmission state, according to an embodiment,

FIG. 15F is schematic side-view of variable-transmission sunroof in a full-attenuation state, according to an embodiment;

FIG. 15G is schematic side-view of variable-transmission sunroof in a directional transmission state, according to an embodiment; and

FIG. 15H is a schematic, side-view of variable-transmission medium implemented as a back window of a motor vehicle.

FIG. 16 depicts a flexographic printer configured to deposit attenuating material on a transparent substrate; according to an embodiment of the invention;

FIG. 17 depicts an inkjet printer configured to deposit attenuating material on a transparent substrate; according to an embodiment of the invention;

FIG. 18 depicts an inkjet printer in which the printing heads are aligned behind each other to enable increased resolution of attenuating material deposited on a transparent substrate according to an embodiment of the invention; and

FIG. 19 depicts a deposition process of laminated optically modifying material on a transparent pane according to an embodiment of the invention.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION OF EMBODIMENTS OF THE INVENTION

The present invention relates to a variable, light-transmission medium in which a pattern of light attenuating and non-attenuating substances are disposed on surfaces of light-transmissive material separated by an inter-surface gap such that transmission through the medium is defined by the angle of incident light. Additional factors effecting transmission will be discussed later in this document.

The following terminology will be used throughout the document.

The terms “substrate” or “layer” refer to a sheet light-transmissive material.

The term “medium” refers to the entire agency or system providing variable light transmission as a function of an angle of incidence, the agency is formed from at least one light-transmissive substrate and associated patterned surfaces of attenuating and non-attenuating regions, inter-surface gaps and any materials filling the gaps, according to embodiments of the invention.

The term “inter-surface gap” refers to the distance between adjacent patterned surfaces. Depending on the particular embodiment, the inters-surface gap may span the thickness of a single substrate having two patterned surfaces, the thickness of a plurality of substrates, the distance between patterned surfaces of separate substrates separated by a cavity containing gas or liquid, or a transparent solid medium, or a combination of any of the above.

The term “optical density” refers to the light-attenuating properties of a region. A region of “high optical density” transmits less light than a region of “low optical density”.

The term “translucent” herein denotes an attenuating region in which light traversing the medium is scattered or diffused so as to distort an image to a viewer.

The term “attenuation” refers to a change in optical properties of transmitted light achieved through either absorption, reflection, scattering (i.e. diffusion), or a combination of them.

The term “attenuating region” herein denotes a region of material having a high optical density, which reduces light intensity or transmission of a particular wavelength or range of wavelengths. It should be appreciated that spectral-specific attenuating regions attenuating light of a first wavelength and are non-attenuating in regards to a second wavelength are deemed to be attenuating in regard to the first wavelength.

Conversely, “non-attenuating” or “transparent” regions refer to regions that do not effect to the same extent, the wavelength or range or wavelengths of light transmission the attenuating regions attenuate. As a matter of convention, non-attenuating regions are deemed to be non-attenuating regions with respect to the wavelength attenuated in the attenuating regions even if the non-attenuating region is also attenuating for wavelengths different than those attenuated by attenuating regions. (This convention also applies for attenuation and non-attenuation for a range of wavelengths.)

The term “brightness” refers to the light intensity of a scene as sensed by the human eye.

The term “glare” refers to light emanating from a variety of places outside the viewed object and affects the image of that object as perceived by the human eye.

The term “luminance” refers to the amount of light arriving from the viewed scene.

The term “transmission” refers to the passage of light through the substrate, and specifically refers to the fraction of the incident light traversing the variable light transmission medium.

The term “light” includes all forms of electromagnetic radiation in the wavelength range of UV, visible light, IR and far IR and includes sunlight emanating directly from the sun and indirect sunlight.

The term “substantially parallel to the horizontal” refers to an angle equal to or less than 45 degrees from a horizontal plane.

The term “viewing device” includes, inter alia, a mirror, a camera, and a video camera.

The term “deposition process” includes all inter alia, all types of coating, printing, lamination, painting, and sputtering. The term “visor” refers to a device whose primary functionality is to reduce the passage of light whereas the term “window” refers to device whose primary functionality is enablement of the passage of light. “Building visors” also refer to awnings and roofs for the purposes of this document.

It should be noted that any combination of described embodiments or features are included within the scope of the present invention.

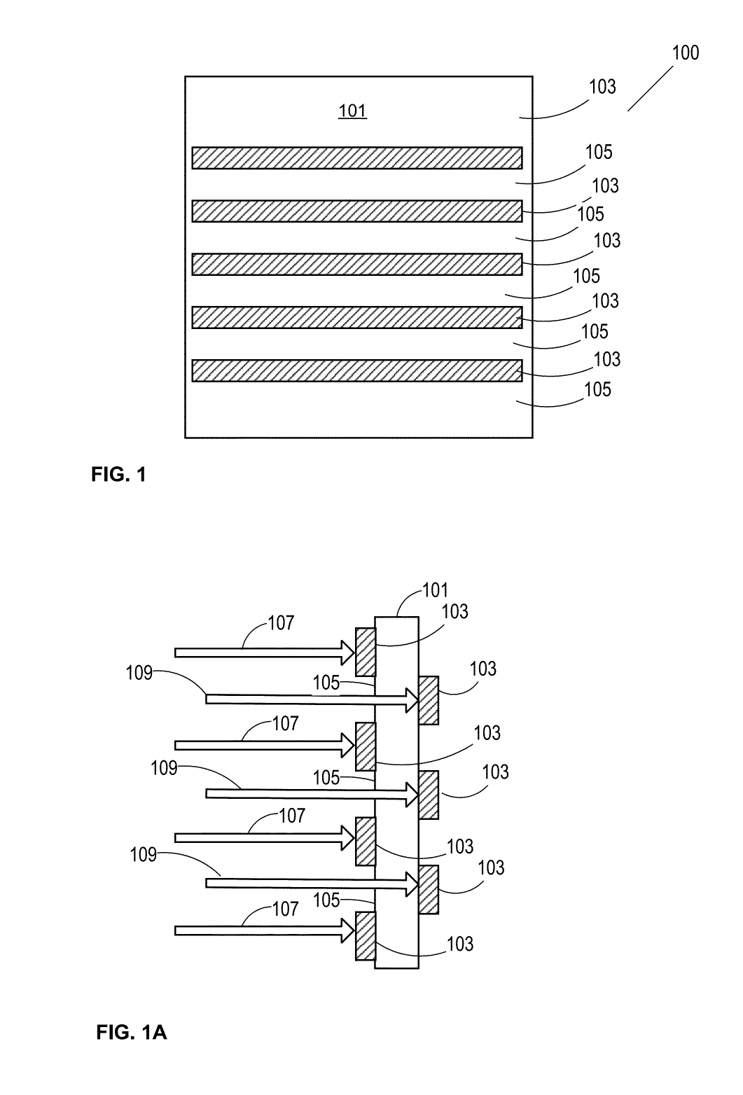

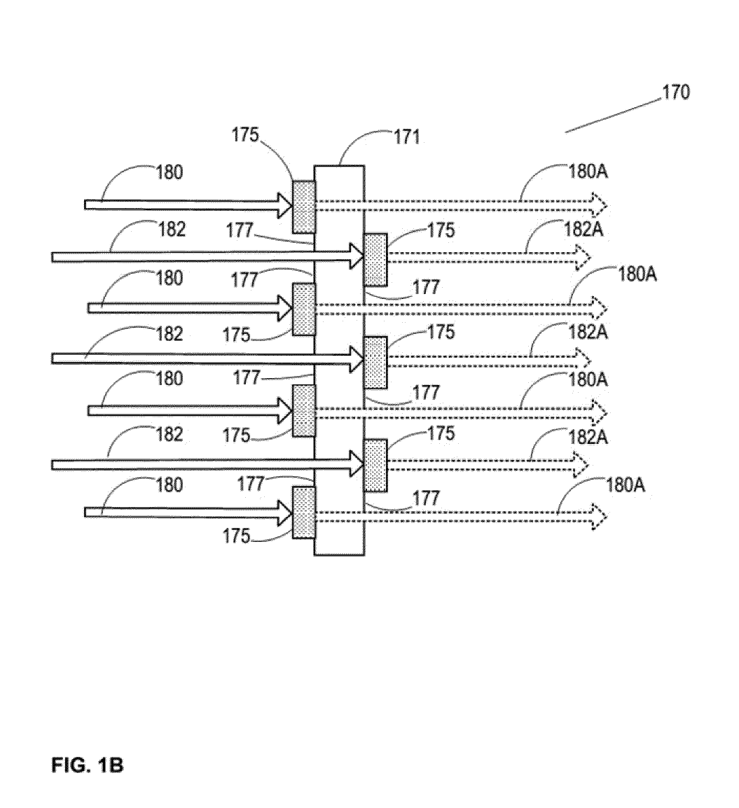

Turning now to the figures, FIG. 1 depicts a front view of a variable transmission medium 100 formed from a light transmissive substrate 101, or layer, and a pattern of attenuating and non-attenuating regions, 103 and 105, respectively, disposed on the front and back surfaces. (The pattern on the back surface is not shown in FIG. 1 for the sake of clarity only.)

FIG. 1A is a side view of substrate 101 of FIG. 1 and depicts two patterned surfaces of attenuating regions 103 and non-attenuating regions 105 in which attenuating regions 103 of each surface are disposed opposite non-attenuating region 105 of the opposing surface when substrate 101 is disposed perpendicularly to incident light 107 and 109. As shown, incident light 107 is blocked by attenuating regions 103 disposed on the front surface whereas incident light 109 traverses non-attenuating regions 105 and is blocked by attenuating regions 103 disposed on the back surface so as to entirely block light passage through the medium 101, according to an embodiment.

### Substrate Materials

Substrate 101 may be constructed from a wide range of light transmissive materials including; inter alia, glass, polymer, non-polymeric resin, polycarbonate, acrylic, etched transparent material, photographic or non-photographic film, and laminate of micro lenses, or a lenticular system.

Various types of glass include, inter alia, float glass, soda-lime glass, borosilicate glass, and crystallized glass.

Various types of resin include, inter alia, PET (polyethylene terephthalate), PVB (polyvinyl butyral), EVA (ethylene vinyl acetate copolymer), acrylic, Plexiglas, and cellulose resin.

In some embodiments, substrates are implemented as a mixture of substrate materials as needed to produce the desired transmission as is known to those skilled in the art.

Preferably, substrate 101 has a non-limiting thickness ranging from 0.0001 mm to 30 mm, most preferably between 0.1 mm and 10 mm depending on the particular application. For roofing applications, the thickness may go much higher, up to 60 mm, for example.

### Attenuating and Non-Attenuating Materials

Attenuating regions 103 may be formed from any one or combination of black or colored ink, paint, pigment, synthetic resin laminate; gelatin; poly methyl methacrylate; paper; polyester; and photographic film. Some attenuating regions are implemented as a mixture of attenuating materials or as a plurality of coatings of various types of attenuating materials as needed to produce the desired attenuation as is known to those skilled in the art.

In related, non-limiting embodiments, attenuating regions 103 are formed from, inter alia, visual superposition of two crossed plane-polarizing filters or visual superposition of a left circular polarizing material and a right circular polarizing material.

It should be appreciated, that attenuating regions may be etched into substrate 101 in certain embodiments.

In certain non-limiting embodiments either attenuating regions 103 or non-attenuating regions 105 are constructed of materials whose optical properties depend on, or alter the polarization of incident light. Such materials include, inter alia, dichroic materials; birefringent materials; plane polarizing materials; circular polarizing materials; wave plates (such as quarter-wave plates); and optically-active (optical-rotatory) materials.

In certain non-limiting embodiments, attenuating regions 103 are implemented as photovoltaic (PV) cells constructed of materials like, inter alia, of cadmium telluride (CdTe), copper indium gallium selenide (CIGS), dye-sensitized, or organic materials. Non-attenuating regions 105 may be implemented as an uncoated transparent substrate 101 or in certain embodiments as a light-transmissive coating. Light-transmissive coating preferably transmit between 10% and 100% of visible light, even more preferably between 70% and 100%. Such coatings in some non-limiting embodiments have a thickness ranging up to 10 mm, and preferably up to 2 mm.

### Shapes and Dimensions of Attenuating Regions

Attenuating and non-attenuating regions 103 and 105 are implemented as parallel linear regions having a width ranging from 0.001 mm to 100 mm, preferably from 0.01 mm to 2 mm In certain embodiments, these regions are implemented as parallel squares or parallelograms, ranging in area from 0.000001 mm² to 900 cm², preferably from 0.0001 mm² to 4 cm².

In another, non-limiting embodiment, the attenuating and non-attenuating are implemented as regions having at least one curved boundary or non-parallel boundaries, like, inter alia, circles, ellipses, and polygonal regions ranging in area from 0.000001 mm² to 900 cm², and preferably from 0.0001 mm² to 4 cm².

As is known in the art, attenuating areas 103 having a width less than 0.1 mm width approach the resolution threshold of the human eye and are, advantageously, nearly invisible.

Attenuating regions 103 may also be implemented as conductive material arranged as parallel lines with non-attenuating area 105 made of p-type or n-type materials so as to form a photo-electric structure intrinsic to variable transmission medium 101, according to some non-limiting embodiments.

It should be appreciated that surface patterns include surface depositions penetrating slightly into substrate 101 as well as patterned substrate surfaces encased by substrates lacking patterns on the outermost surface.

Furthermore, it should be appreciated that for the clarity of illustration some figures depict attenuating regions disposed within the body of a substrate; however, it should be appreciated that all attenuating patterns are implemented as surface patterns.

FIG. 1B is schematic side view of a single substrate embodiment of a variable transmission medium 170 configured to allow a degree of visibility even when disposed in a minimal transmission state, according to a non-limiting embodiment.

Specifically, substrate 171 has parallel patterned surfaces of partially-attenuating regions 175 and non-attenuating regions 177, according to an embodiment of the invention. Partially-transparent regions 175 block 90% of incident light 180 and 182, so that the resulting intensity of light 180A and 182A is only 10% of the intensity of light 180 and 182. It should be appreciated that a wide degree of partial-attenuation is included within the scope of the present invention.

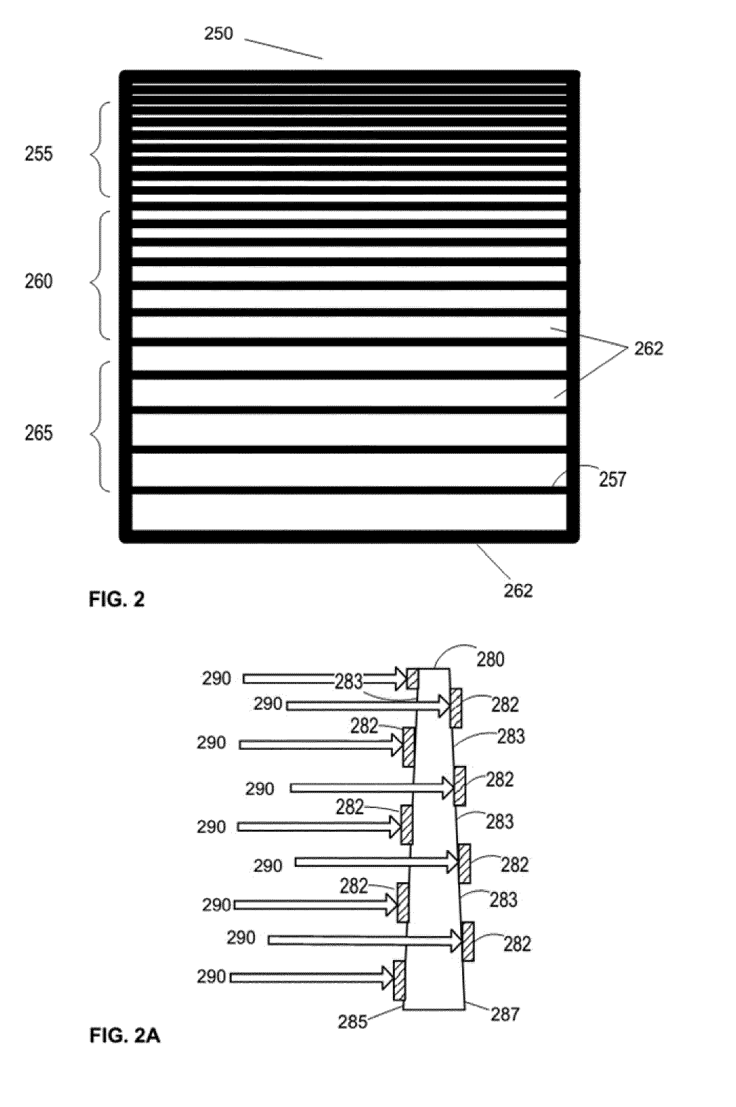

FIG. 2 depicts a graduated attenuating pattern 250 of a variable transmission medium according to a non-limiting, embodiment of the invention. The density of attenuating regions 257 (i.e. the number of attenuating regions per surface area of substrate) in an area 255 at the top of the pattern is higher than the density of attenuating regions in an area 260 in the center of the pattern, which in turn is higher than the density of attenuating regions 257 in an area 265 at the bottom of the pattern, so that an image is dimmed more at the top than at the bottom making it useful for applications requiring greater attenuation at the top of the substrate.

In related embodiments, the width of each non-attenuating region 262 changes as a function of its distance from a substrate edge 264.

In other embodiments of the invention, a similar effect is achieved by varying the optical density of either individual attenuating region 257 or individual non-attenuating region 262 (or groupings of the same) as a function of placement within the medium.

FIG. 2A depicts a substrate 280 of a variable transmission medium having a trapezoidal cross-section in which a pattern of attenuating and non attenuating regions, 282 and 283 respectively, are disposed on opposing non-parallel surfaces 285 and 287, according to an embodiment. As shown, perpendicularly incident light rays 290 are blocked by attenuating regions 282. Such configurations advantageously provide graduated attenuation upon rotation as will be further discussed.

In certain embodiments, substrates are implemented with arcuate, partially arcuate, or wavy surface geometries.

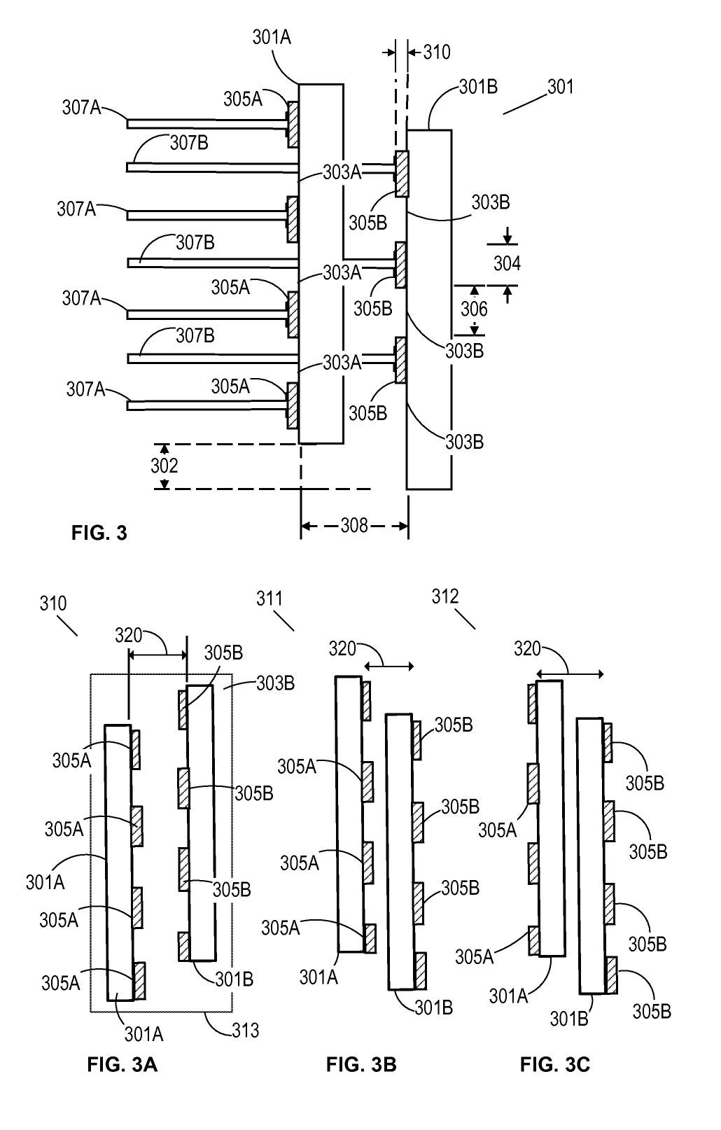

FIG. 3 depicts a double-substrate, variable transmission medium 301 in a complete attenuating state, according to an embodiment of the invention. Substrate 301A has one patterned surface of attenuating and non-attenuating regions 305A and 303A, and similarly, substrate 301B has a patterned surface of attenuating regions 305B and non-attenuating regions 303B. Substrates 301A and 301B are offset by an offset distance 302 so that light rays 307A are blocked by attenuating regions 305A, and light rays 307B are blocked by attenuating regions 305B; no light is visible through variable transmission medium 301.

As shown, attenuating region width 304 and non-attenuating region width 306 are constant, although in some embodiments these parameters vary as will be further discussed. An interlayer gap 308 is measured as the distance between the substrate side of attenuating material deposition of region 305A and the substrate side of attenuating material deposition of region 305B. In view of the fact that attenuating material has a particular thickness, the distance between attenuating layers may be measured at any thickness of each attenuating material as long as the same reference point is used consistently. As a matter of convenience, the measuring point to be used throughout this document is the substrate surface on which each attenuating layer is disposed; i.e. an inter-surface gap. It should be appreciated that thickness of attenuating material of attenuating region 310 is exaggerated in the drawings for emphasis; but, according to various embodiments of the present invention, attenuating region thickness 310 should be as thin as possible and is typically implemented with a thicknesses much less than inter-surface gap 308.

In general, essential features defining light transmission through variable transmission medium 301 from a particular viewing angle include:

Inter-surface gap 308;

Width 304 of attenuating regions;

Opacity or optical density of attenuating regions 305A and 305B;

Reflectivity and scattering characteristics of attenuating regions 305A and 305B;

Angle of incidence of light on the medium;

Viewing angle;

Dimensions of the non-attenuating regions 306 between attenuating regions within a patterned surface;

Thickness 310 of attenuating material; and

Substrate opacity.

FIGS. 3B-3D depict three embodiments, 310, 311, 312, in which attenuating materials 305A and 305B are deposited on a surface of two substrates 301A and 301B, respectively, forming a patterned surface on each. Specifically, embodiment 310 depicts attenuating materials 305A and 305B deposited on opposing surfaces of substrates 301A and 301B and enclosed in a transparent casing 313. An inter-surface gap 320 is measured from the surfaces on which the attenuating materials 305A and 305B are deposited. Similarly, in embodiments 311 and 312 in which attenuating materials 305A and 305B are deposited on corresponding or opposing surfaces of substrates 301A and 301B, respectively, the inter-surface gap 320 is always measured from the surfaces on which the attenuating materials 305A and 305B are deposited. The inter-surface gap 320 is a primary factor in defining the degree of rotation required to achieve the visual superposition of an attenuating region of a first patterned surface onto a non-attenuating region of a second patterned surface.

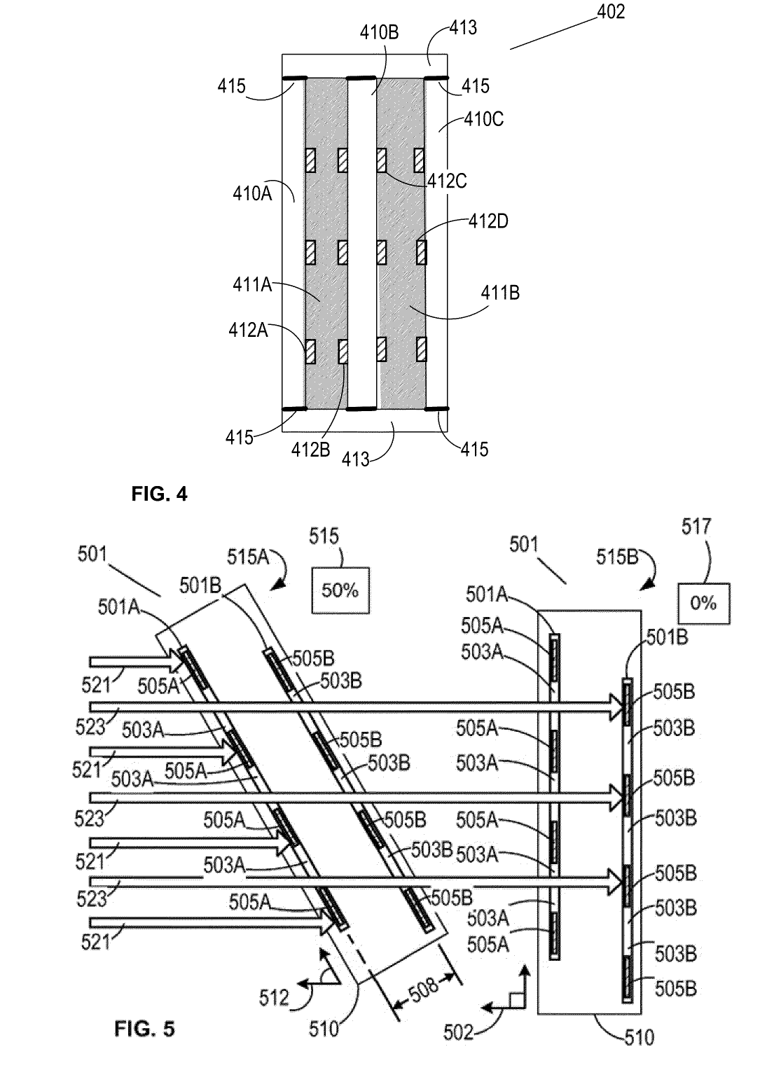

FIG. 4 is cross-sectional view of a non-limiting embodiment of a variable transmission medium 402 formed from three substrates, 410A, 410B, and 410C, stabilized by support elements 413 disposed at their upper and lower extremities to form a first cavity 411A between substrates 410A and 410B and second cavity 411B between substrates 410B and 410C. Sealant 415 is disposed between substrates 410A, 410B, and 410C and support elements 413 to enable leak-free containment of liquid or gas, according to non-limiting embodiments.

Sealant 415 may be formed from sealing materials like, inter alia, rubber, latex, resin, silicone, polymer, or nylon and glued to the relevant substrates 410A, 410B, 410C and support elements 413.

Attenuating regions 412A and 412D are disposed on inner surfaces of substrate 410A and 410C, respectively, to advantageously protect attenuating regions from wear and tear had they been disposed on the outer surfaces of substrates 410A and 410C. Additional attenuating regions 412B and 412C are disposed on the outer surfaces of middle substrate 410B, according to an embodiment.

In operation, gas or liquids disposed in cavities 411A and 411B advantageously provides an inter-surface gap between adjacent patterned surfaces while reducing image distortion and undesirable substrate attenuation resulting from light transmission through solid materials. Suitable liquids include, inter alia, water, whereas suitable gases include, inter alia, air, argon, krypton or a mixture of them.

FIG. 5 depicts light transmission through patterned substrates as a function of an angle of light incidence. Variable transmission medium 501 includes substrates 501A and 501B, each having parallel, non-attenuating linear regions 503A and 503B, respectively, and parallel linear attenuating regions 505A and 505B, respectively, according to an embodiment of the present invention. Substrates 501A and 501B are held at an inter-space gap 508 inside transparent housing 510 to ensure that they rotate in unison.

As shown in orientation 515A, substrates 501A and 501B of variable transmission medium 501 are simultaneously disposed at an acute angle 512 relative to light rays 521 and 523, light rays 521 incident on attenuating regions 505A are blocked, whereas light rays 523 pass through non-attenuating regions 503A and 503B thereby allowing about 50% transmission 515.

When variable transmission medium 501 is rotated clockwise to orientation 515B a right angle 502 is formed with respect to light rays 521 and 523, and attenuating regions 505B of substrate 501B are visually superimposed on non-attenuating region 503A of substrate 501A such that light rays 523 now incident on attenuating regions 505B are also blocked, thereby achieving substantially zero transmission 517, according to a non-limiting embodiment of the invention.

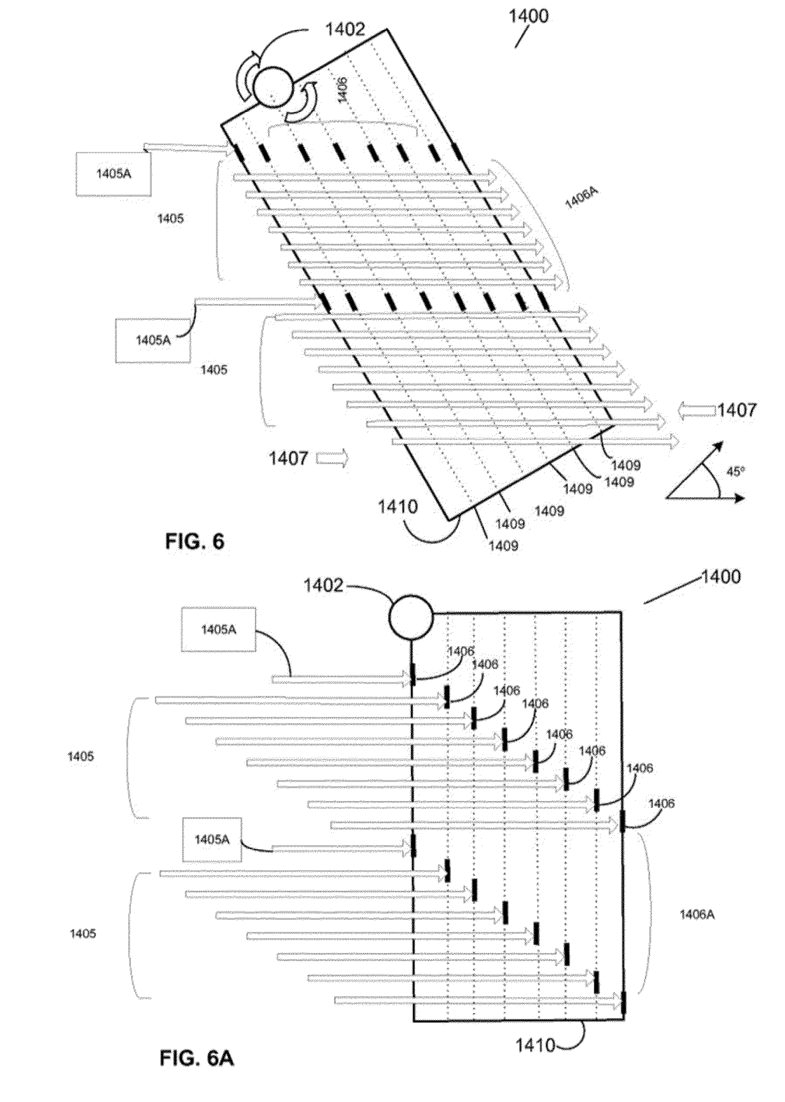

FIGS. 6-6A depict a multi-substrate embodiment of a variable transmission medium 1400 disposed in maximum and minimum transmission positions, respectively. Generally, the multi-substrate embodiment is designed to increase light transmission by increasing the number of abutting, patterned substrates in the body of a variable transmission medium 1400 and enlarging the surface area of the non-attenuating regions. Medium 1400 is formed from multiple substrates 1409; each having at least one patterned surface of attenuating regions 1406 and relatively wide non-attenuating regions 1406A. In non-limiting, exemplary embodiments, attenuating regions 1406, implemented as attenuation lines 1406, have a thickness of 0.1 mm and substrates 1409 has an approximate thickness of 0.4 mm forming a composite medium thickness of about 3.0 mm as noted above.

Specifically, FIG. 6 is a schematic, side view of a variable-transmission, medium 1400 in a maximum transmission state in which a bottom edge is disposed at about a 45 degree angle relative to the horizontal.

As shown in a non-limiting embodiment, attenuating regions 1406, implemented as attenuation lines are in direct alignment with other so as to entirely overlap with each other when medium 1400 is disposed in a full transmission state so that only incident rays 1405A are blocked by outmost attenuation line 1406 whereas remaining incident rays 1405 pass freely through relatively broad non-attenuating region 1406A advantageously reducing undesirable transmission losses relative to losses of single or double substrate embodiments.

It should be appreciated that the reduction of the number of optically active edges associated with attenuation lines 1406 advantageously reduces aberrations caused by diffraction.

It should be appreciated that embodiments in which attenuation lines 1406 do not fully overlap while medium 1400 is disposed in the maximum transmission state are also included within the scope of the invention. Furthermore it should be appreciated that in certain embodiments, straight or curved attenuation lines traversing non-horizontal dimension of medium 1401 are included within the scope of the invention.

Medium 1400 is rotatably mounted along one edge to a support structure (not shown) by way of hinge 1402 so as to enable medium rotation upon application of a force 1407 to medium 1400 in either direction perpendicular to the hinge axis. In certain embodiments, a force 1407 is applied mechanically to medium 1401. For example, in certain embodiments, force 1407 is applied by way of a motor linkage controlled by a user or configured to respond to changes in lighting, for example as noted above.

It should be noted that embodiments in which hinge 1402 is mounted along any edge or at one or more points are included within the scope of the present invention.

FIG. 6A depicts medium 1400 of FIG. 6 after rotation into a position in which the bottom edge 1410 is parallel with the horizontal and transmission though medium 1401 is fully blocked. As describe above, rotation of medium 1401, causes the cumulative thickness of attenuation lines 1406 of the non-outer layers 1406 to progressively attenuate transmission through medium 1401 as they move into a non-overlapped state and collectively span non-attenuating region 1406A.

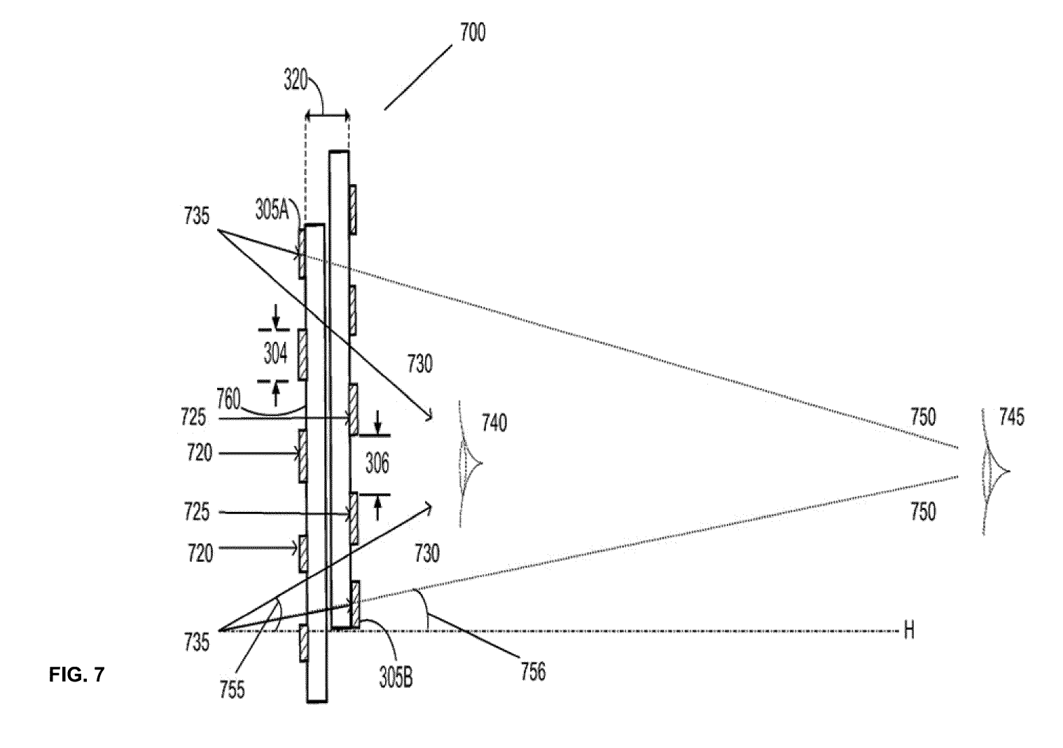

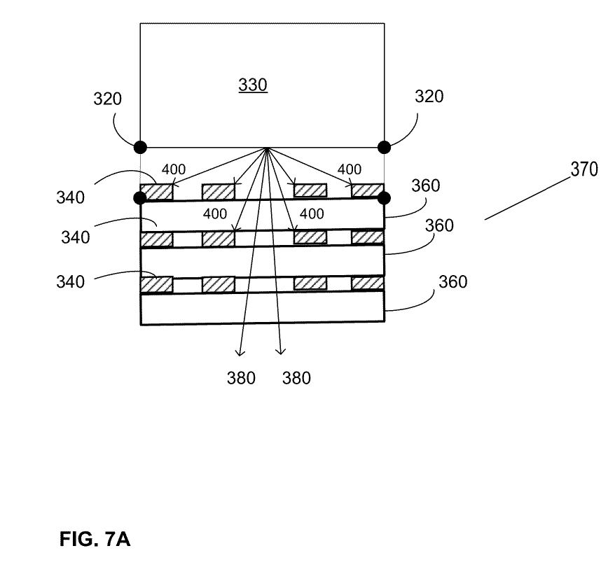

FIG. 7 depicts a banding phenomenon visible to an observer viewing at a relatively close distance.

Attenuating regions 305A and 305B are completely out of phase with each other and therefore block perpendicularly incident light 720 and 725, such that the variable transmission medium 700 assumes a state of maximum opacity. However, such opacity will be observed in an area generally opposing the observer viewing from a relatively close position 740. Light rays 735 emanating from point 730 viewed from position 740 traverse medium 700 between attenuating regions 305A and 305B, thereby forming localized bands of light transmission.

These localized bands of reduced opacity, or transmission bands, below and above the opaque center change in accordance with changes in viewing angle 755, or inter-layer gap 320, or width of the attenuating regions 304, or width of the non-attenuating regions 306, or a combination of them.

In some embodiments when the attenuating regions are implemented as non-linear geometrical figures, the transmission bands will appear in accordance with the particular geometrical figure of the attenuating region and may be modulated in accordance with changes in the inter-surface gap as is known to those skilled in the art.

As shown, as an observer at observation point 740 moves away from medium 700 to observation point 745, the viewing angle 756 decreases from angle 755 to angle 756 so that previously visible light emanating from point 735 is entirely attenuated by attenuating regions 305A and 305B when viewed along lines of sight 750 from distant observation point 745, according to certain non-limiting embodiments.

In certain applications such banding phenomenon may be exploited to produce a single darker band positioned in the top region variable transmission medium 700 so that light coming in this region will be more attenuated, providing more visual comfort.

In other non-limiting embodiments, variable transmission medium 700 is implemented as a translucent partition configured to provide an attenuated image when viewing from a distance greater than about one meter and an un-attenuated image of either the floor or the ceiling when viewing at a distance less than about one meter from the partition.

In certain other non-limiting embodiments, the variable transmission medium is implemented as a partition having a translucent band of about one meter in height disposed in the middle of the partition so as to blur imagery of the non-viewer's side of the partition opposing the band. The translucent band effectively shifts in accordance with changes in the viewing angle, thereby ensuring distortion of imagery opposite the translucent band.

FIG. 7A depicts a display screen cover 370 configured to provide directional viewing of a display or monitor screen 330 by blocking unwanted viewing angles, according to an embodiment. Specifically, screen cove 370 includes a plurality of light-transmissive substrates 360 each having a pattern of attenuating regions 340 and non-attenuating patterns.

Substrates 360 are in abutment with each other and each respective pattern in alignment so that the attenuating regions 340 restrict the viewing field to about 10°-30° visible to a viewer standing substantially pendicularly to a plane defined by display device 330. The plurality of substrates 360 forms a unit mounted to the monitor 370 by way of a connector 320 as is known to those skilled in the art. However, it should be noted that both permanent and releasable connectors 320 are included within the scope of the present invention.

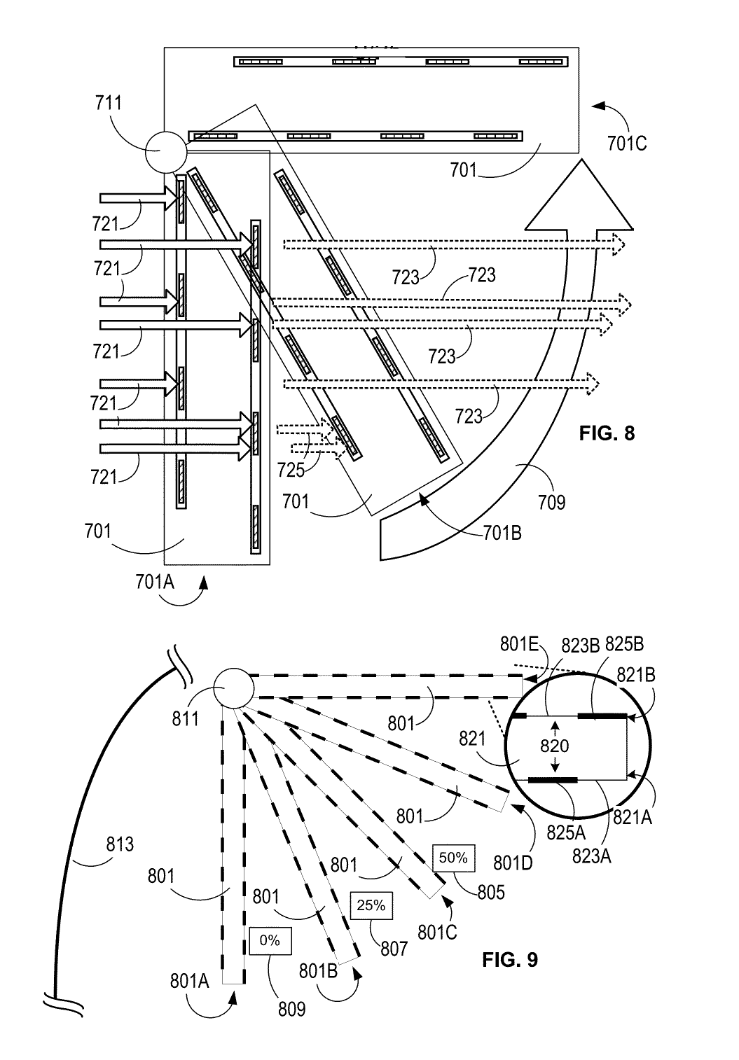

FIG. 8 depicts a variable transmission medium implemented as a visor or window 701 installed either in a motor vehicle or a building and positioned at different angular orientations 701A, 701B, and 701C, via a movement 709 about a pivot 711. Light transmission through the space of the motor vehicle or the building may then be regulated as a function of angular orientation of the visor or window 701, according to an embodiment of the invention. Without limiting the scope of the variable transmission medium, it will be discussed in FIGS. 8-10 in terms of an automotive visor.

In orientation 701A, light rays 721, from the scene ahead of the motor vehicle, are incident onto visor 701 and are entirely blocked. However, when visor 701 is rotated into orientation 701B some rays 725 are blocked while other rays 723 pass through visor 701. In orientation 701C, visor 701 is out of the line of travel of the light resulting in complete transmission of light.

FIG. 9 depicts a single-substrate visor 801 having parallel, patterned surfaces 821A and 821B (as illustrated in the magnified inset) on a single transparent substrate 821, as installed in a motor vehicle and positioned at various angular orientations 801A, 801B, 801C, 801D, and 801E, about a pivot 811 behind a windshield 813, with light transmission dependent on angular orientation, according to an embodiment of the invention. Visor 801 at orientation 801A perpendicular to incident light rays transmits substantially 0% of the incident light intensity to a location 809; visor 801 at orientation 801B transmits approximately 25% of the incident light intensity to a location 807; and visor 801 at orientation 801C transmits approximately 50% of the incident light intensity to a location 805. Attenuating regions 825A and 825B are printed on surfaces 821A and 821B, respectively, of transparent substrate 821, with transparent regions 823A and 823B, respectively, left unprinted with attenuating material, as illustrated in the magnified inset. In this embodiment the inter-surface gap 820 between the layers is the thickness of the substrate 821.

It should be noted that the embodiments of FIGS. 8 and 9 show the visor to minimal transmission at a position perpendicular to the light coming from the scene. This can be modified by changing the relative positions of the attenuating region pattern in the various layers. For example, a shift of the whole layer pattern in one layer relative to another such that the attenuating regions will superimpose at perpendicular angle to the scene light, will cause the brightest image at that angle, while tilting the visor away from the perpendicular (in both directions) will diminish the amount of light transmitted.

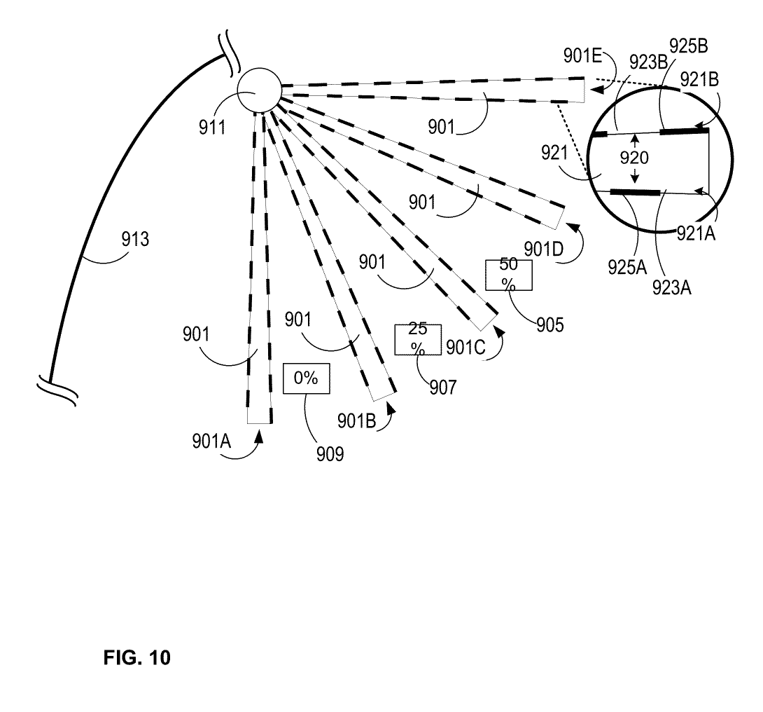

FIG. 10 conceptually shows a single-substrate visor 901 installed in a motor vehicle and positioned at various angular orientations 901A, 901B, 901C, 901D, and 901E, about a pivot 911 behind a windshield 913. As illustrated in the magnified inset, visor 901 has non-parallel, patterned surfaces 921A and 921B in which the inter-surface gap between the patterned surfaces change as a function of distance from the pivoted edge. Light transmission is dependent on angular orientation. Visor 901 at orientation 901A perpendicular to incident light rays transmits substantially 0% of the incident light intensity to a location 909; visor 901 at orientation 901B transmits approximately 25% of the incident light intensity to a location 907; and visor 901 at orientation 901C transmits approximately 50% of the incident light intensity to a location 905. Attenuating regions 925A and 925B are printed on surfaces 921A and 921B, respectively, of transparent substrate 921, with transparent regions 923A and 923B, respectively, left unprinted with attenuating material, as illustrated in the magnified inset.

The varying inter-surface gap 920 advantageously provides maximum attenuation near the top of the medium with gradually-increasing transmission towards its bottom region making it especially useful for reducing glare near the upper region of windshield 913.

It should be appreciated that in any of the embodiments shown in FIGS. 8-10 the pivot axis may be disposed along any suitable axis.

The variable transmission medium shown in FIGS. 8-10 may be tilted manually or through automated means.

In some embodiments, the motor is actuated manually whereas in fully automated embodiments, the motor is actuated responsively by a sensor mechanism configured to maintain a preset, user-defined brightness or heat level.

It should be appreciated that both visor and window applications have application in buildings and motor vehicles like, inter alia, cars, trucks, buses, trains, airplanes, boats and motorcycles.

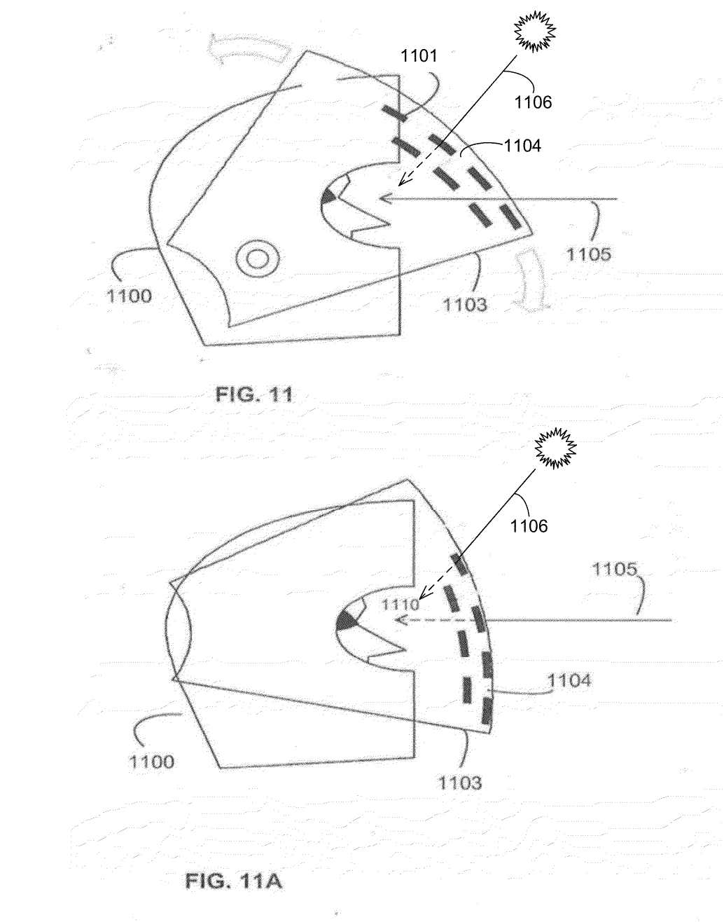

FIG. 11 depicts a motorcycle helmet 1100 having a pivotally-mounted variable transmission medium implemented as motorcycle helmet visor 1103 with two patterns of partially-attenuating regions 1101 and non-attenuating regions 1104. As shown, the viewer receives non-attenuated light from the scene ahead as light ray 1105 traversing non-attenuating region 1104 between partial-attenuation lines 1101. In this configuration, the scene in front of the driver is the brightest through visor 1103.

FIG. 11A depicts helmet visor 1103 of FIG. 11 after rotation into a reduced transmission state in which image intensity from the scene ahead 1105 is partially attenuated by partial-attenuating region 1101 so that the wearer receives about 10% of the original intensity as shown in rays 1110, according to non-limiting embodiments.

The degree of rotation required to achieve the desired brightness is subject to the above noted parameters defining transmission as a function of angle of incidence. Due to the sun's higher angle, the direct sun light glare will be reduced in most positions of rotation of the visor 1103.

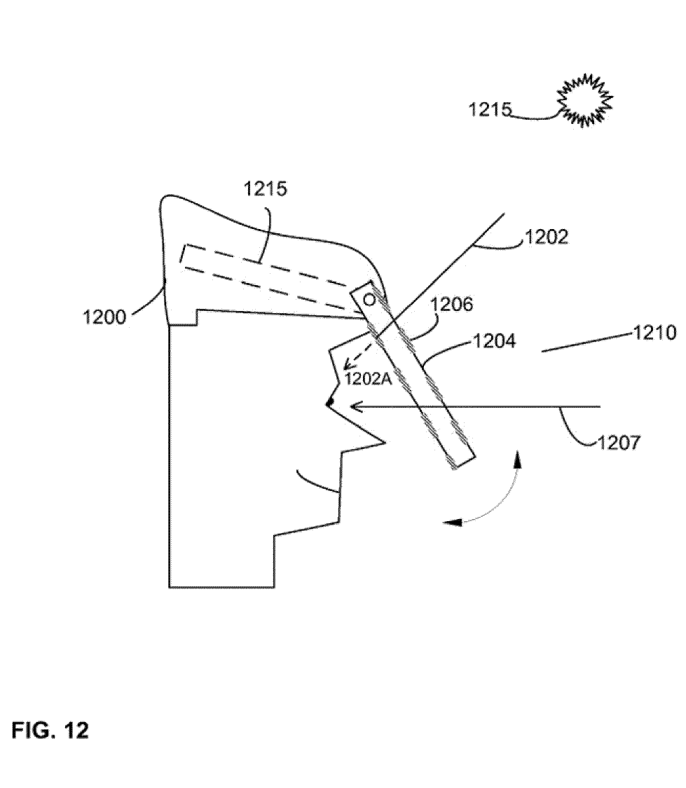

FIG. 12 is a schematic view of a variable transmission medium implemented cap visor 1210 pivotally mounted to a cap 1200 in a manner analogous to the motorcycle visor of FIGS. 11 and 11A. Cap visor 1200, in a non-limiting embodiment, is implemented as a single, parallel surfaced substrate having two patterned surfaces; each having partially-attenuating regions 1206 and non-attenuating regions 1204 configured to reduce direct sunlight exposure 1202 and image light 1207 when desired. When visor 1210 is not in use, it may be folded into a receiving pocket 1215 formed into cap 1200.

As shown, cap visor 1210 is disposed in a state allowing maximum light transmission of image light 1207. At the same time and disposition, glare emanating directly from sun 1215 is reduced by attenuating sunray 1202 into reduced intensity ray 1202A as it passes through partially-attenuating region 1206, according to a non-limiting embodiment.

It should be appreciated that the partially-attenuating regions 1206 are configured to partially attenuate so as to ensure that the view ahead will always be visible to the wearer; at least 10% of the original transmission intensity is visible to the wearer, in a non-limiting, exemplary embodiment.

In certain, non-limiting embodiments partially-attenuation regions 1206 as well as non-attenuating regions 1204 disposed on the cap visor 1210 are formed from heat reflective materials toward the sun to reflect heat and facilitate cooling. Furthermore, in addition to the visual benefits of glare reduction, there may also be certain health benefit resulting from reduction of wavelengths that may endanger health. Specifically, in certain embodiments, partially-attenuation regions 1206 may be configured to allow transmission of certain healthier sections of the electromagnetic spectrum while blocking the more harmful sections. It should be appreciated that visors non-pivotally mounted to a cap are also included with the scope of the present invention.

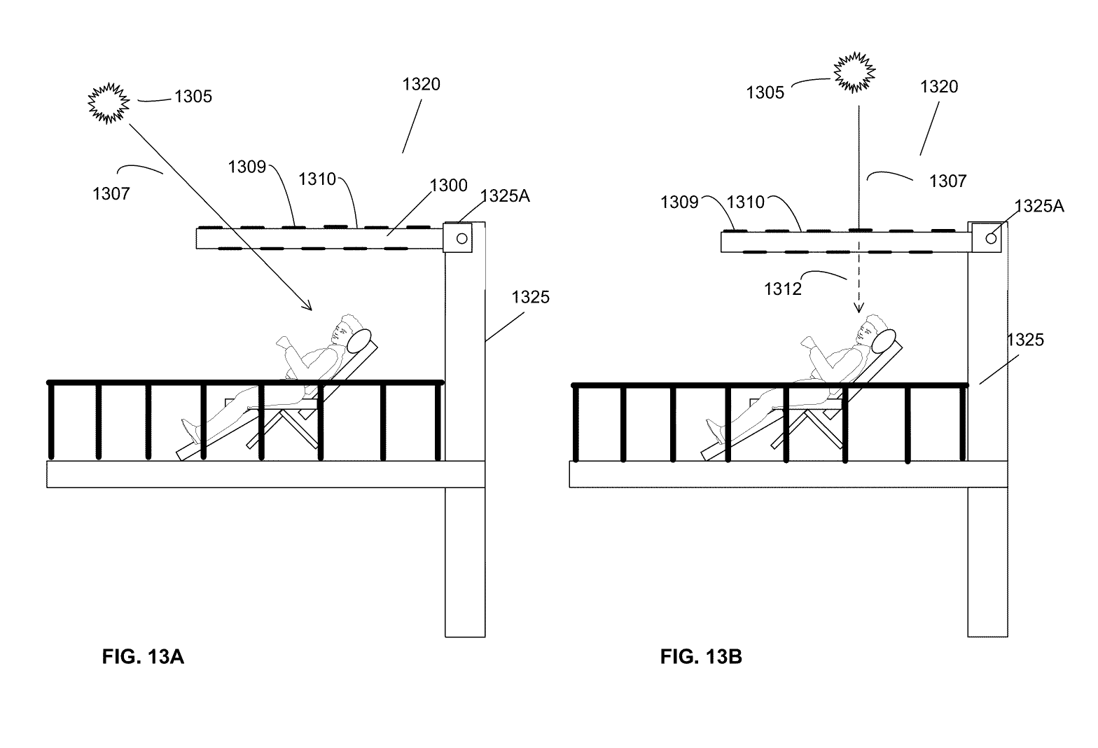

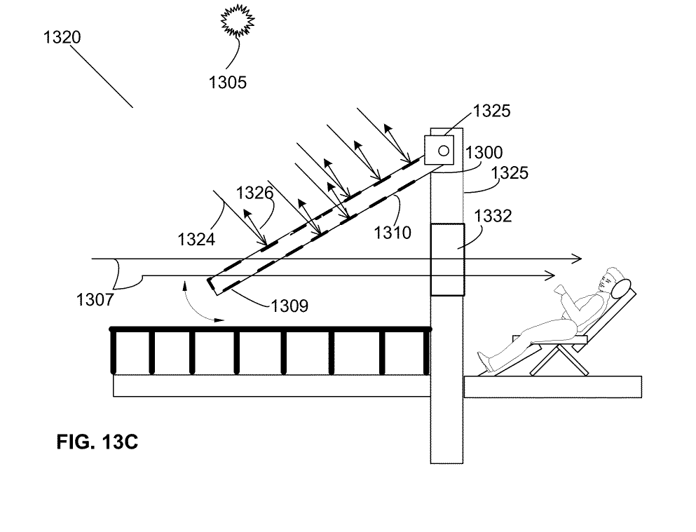

FIGS. 13A and 13B are schematic views of a non-limiting embodiment of a variable transmission medium implemented as a building visor 1320 in which light transmission varies as a function of the changing angle of incidence as the sun 1305 travels through its trajectory. As shown in visor embodiments above, building visor 1320 is implemented as a single substrate 1300 having two patterned surfaces of attenuating and non-attenuating regions, 1309 and 1310, respectively. In certain embodiments, visor 1320 is mounted to building 1325 by way of a building mount 1325A having rotational capability enabling a user to set an angle at which visor 1320 is disposed, according to an embodiment. In a certain embodiment, visor 1320 is rigidly mounted.

As shown, building visor 1320 is mounted to building wall 1325; however, it should be appreciated that embodiments in which building visor 1320 is not mounted directly to wall 1325 and provides such shade to areas associated with the building, or is implemented as “stand alone” structure totally detached from other edifices are all included within the scope of this invention. Furthermore, it should be appreciated that the term “building” refers to both permanent and temporary structures that in addition to sheltering people, also shelter animals, plants, and various items of interest.

In operation, when sun 1305 is disposed in the lower portion of the sky, as shown in FIG. 13A, light 1307 traverses visor 1320 through non-attenuating areas 1310 and when sun 1305 is disposed directly overhead, as shown in FIG. 13B, incident light 1307 traverses attenuating regions 1309 as dimmed light 1312 such that an observer under visor 1320 experiences time-based shading or transmission. In certain, non-limiting embodiments, attenuation regions 1309 are formed from heat reflective materials to facilitate cooling as will be further discussed.

FIG. 13C is a schematic view of a building visor 1320 of FIGS. 13A and 13B pivoted into a seasonal position effectively changing its transmission and reflection characteristics to account for seasonal changes in sunlight intensity, according to a non-limiting embodiment.

Specifically, during cooler winter months, time-variant transmission is directed on building 1325 and through window 1332 to warm the interior, whereas in the warmer summer, direct sunlight and heat are directed away from building wall 1325 and window 1332, according to a non-limiting embodiment.

As shown, building visor 1320 is disposed in a position in which direct sunlight 1324 is blocked or reflected, whereas light from the scene 1307 traverses visor 1320 into window 1332, while IR radiation 1326 is reflected.

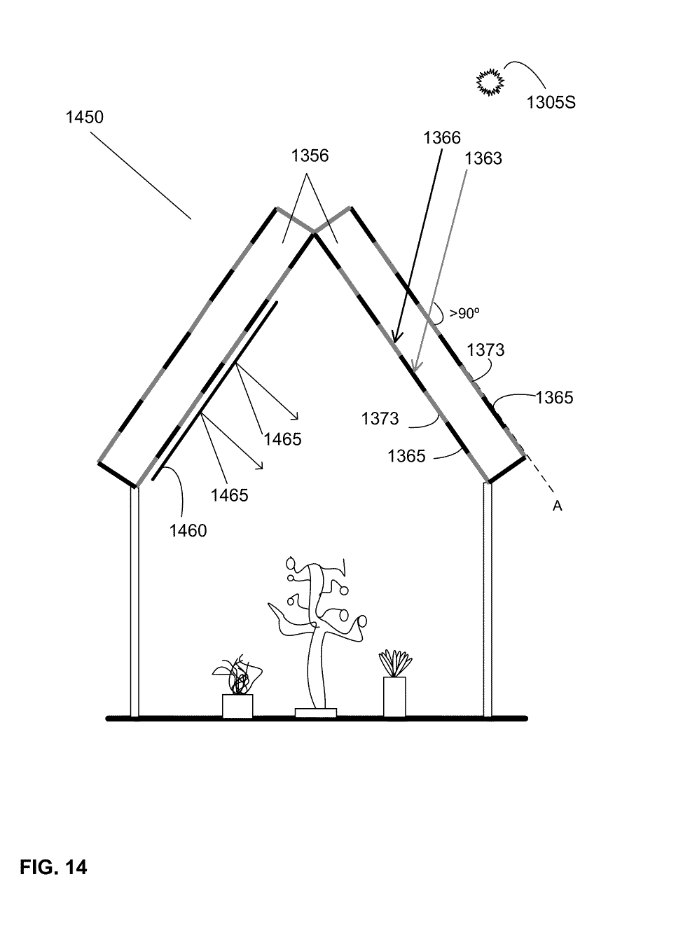

FIG. 14 depicts a building visor of a variable transmission medium implemented as panels 1450 forming a greenhouse roof, according to non-limiting embodiments. By way of introduction, during winter months sometimes certain plants require particular wavelengths of sunlight at full intensity while during summer months, when light and heat intensity are much higher, these plants don't require light of these wavelengths or do require them; but, at lesser intensity.

Accordingly, green house panels 1450 have a plurality of spectral-specific attenuating regions operative as summer and winter attenuating regions for a particular wavelength or range of wavelengths on the basis of the angle of incidence resulting from the solar-trajectory. An angle of incidence in excessive of 90° relative to line “A” is shown as a non-limiting example. Furthermore, it should be noted that panels 1450 are disposed at a substantially horizontal angle, according to an embodiment.

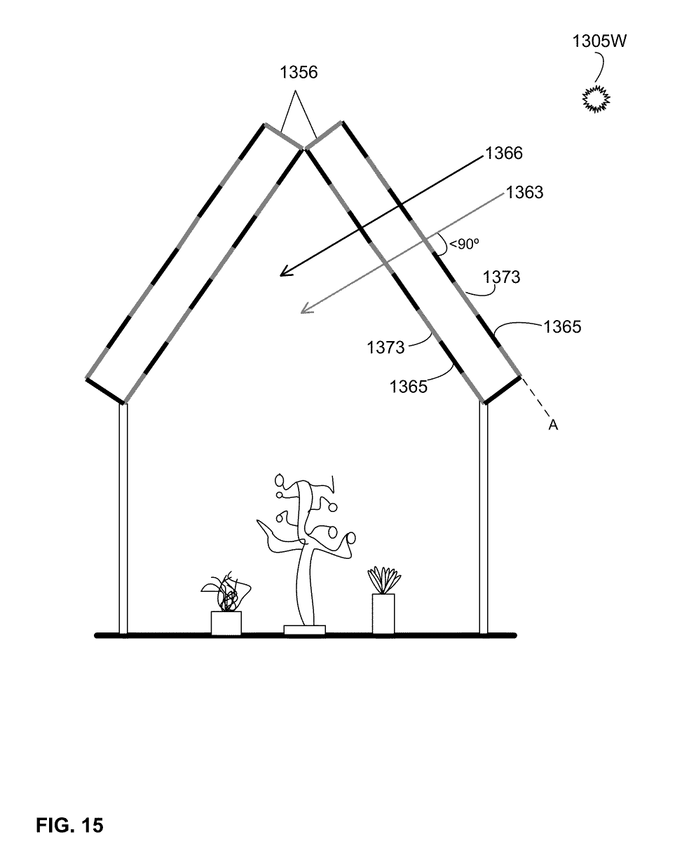

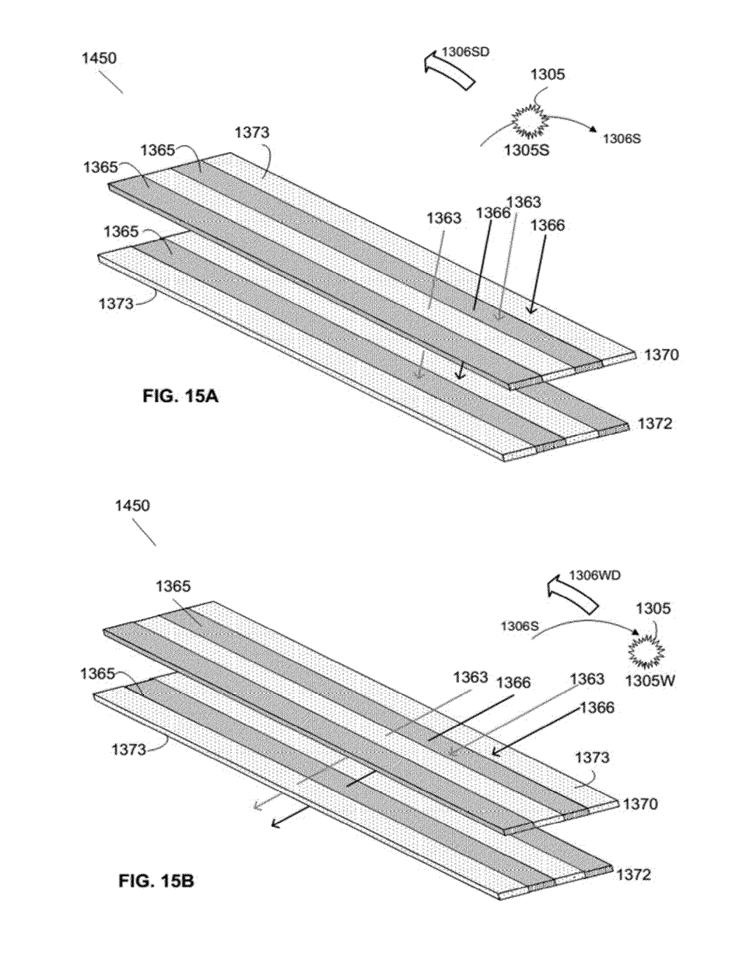

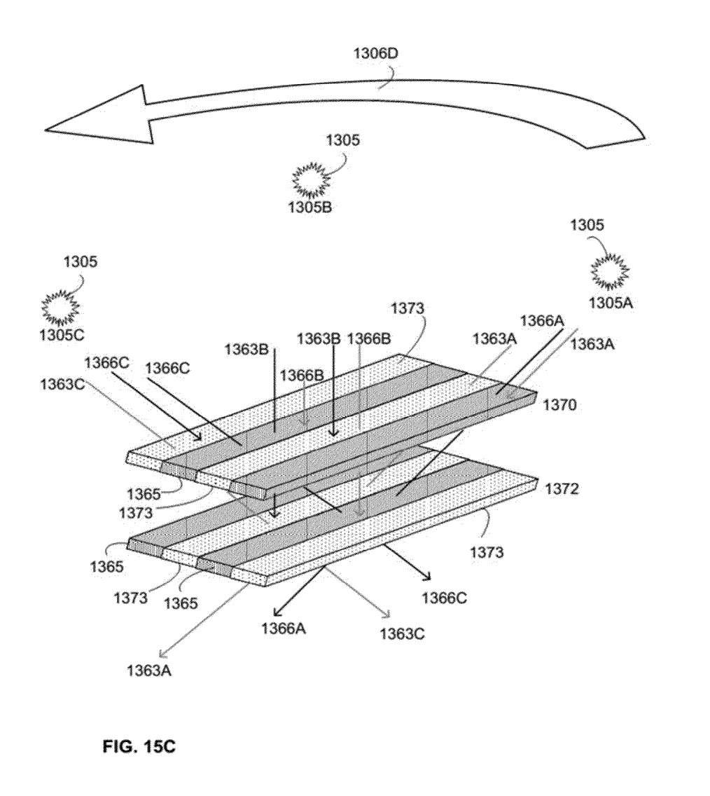

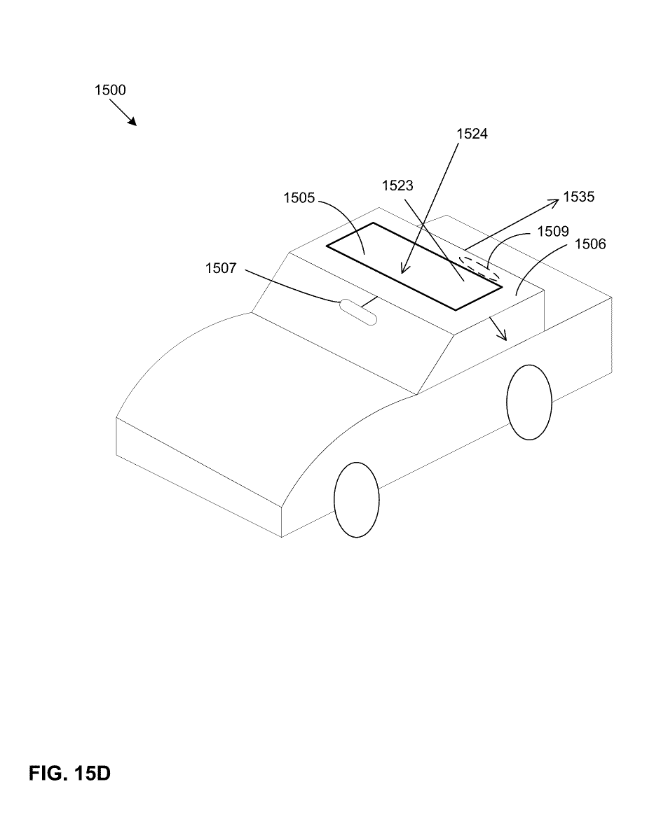

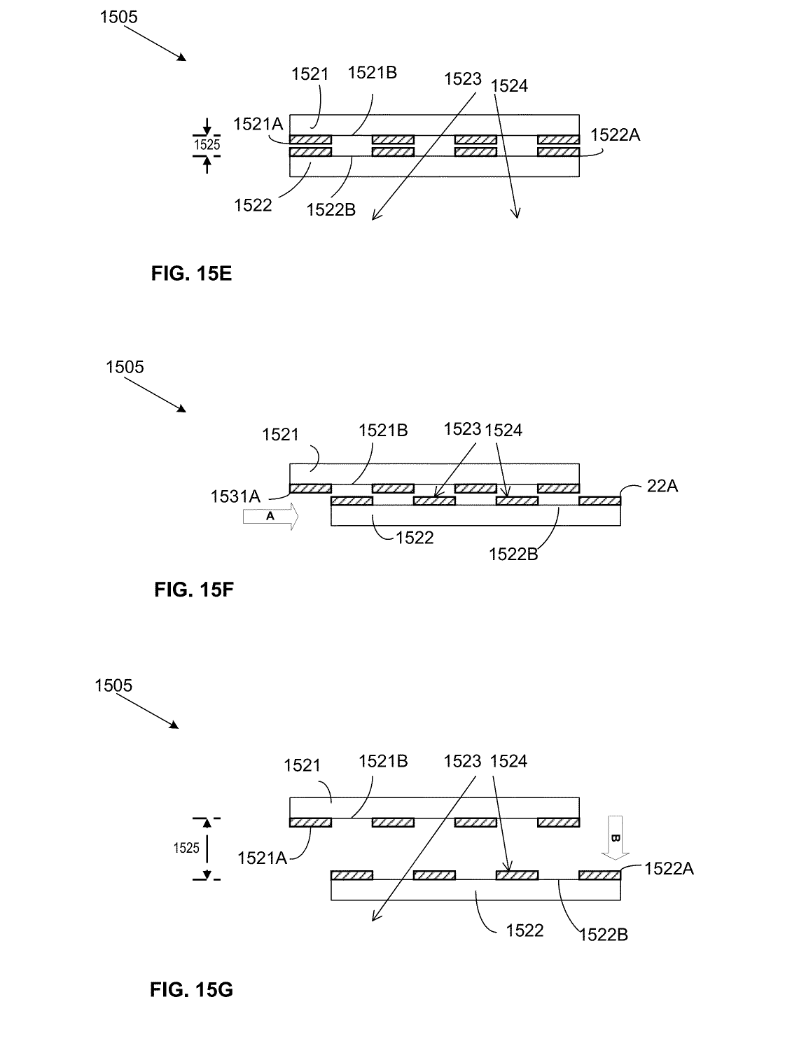

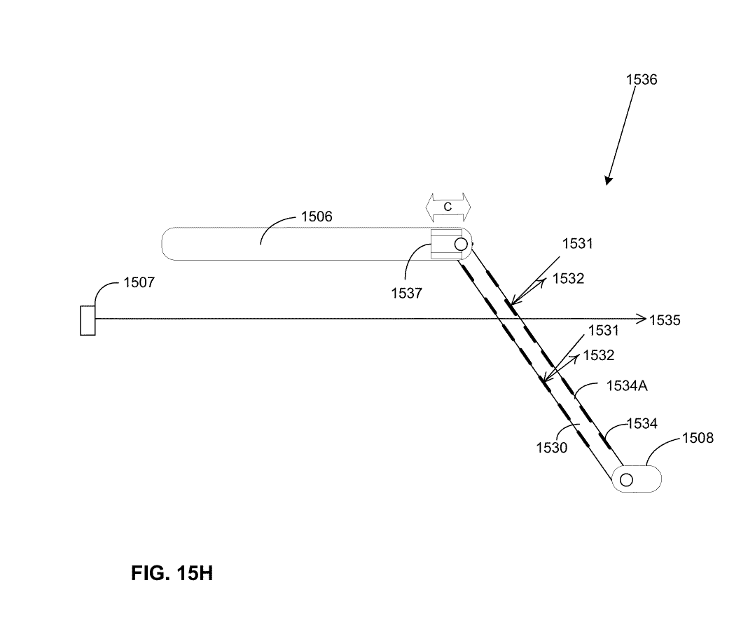

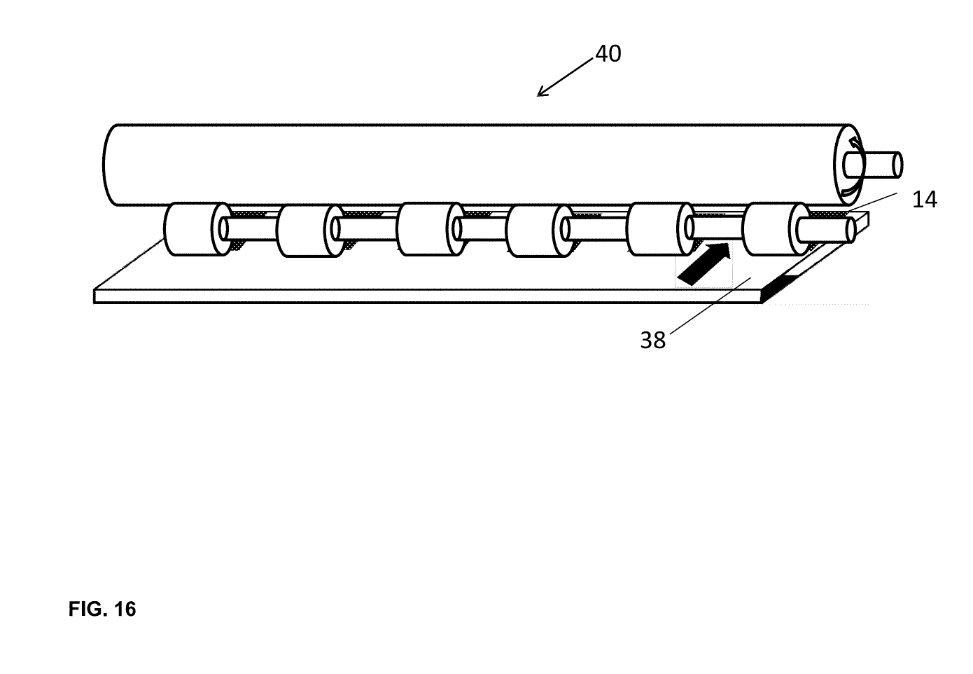

It should be appreciated that for the purposes of clarity, greenhouse applications having spectral-specific attenuation are discussed in FIGS. 14-15B as a function of seasonal changes in light incidence, although panels 1450 can also be responsive to changes in light incidence as a function of the sun position during the day.

By way of a non-limiting example, wavelengths corresponding to colors blue and red are deemed to be detrimental to plants during the summer months and beneficial during the winter months. As shown, each panel 1450 has two opposing surfaces of alternating filter types; blue filter 1365 and red filter 1373. Blue rays 1366 of the incident summer rays travel through blue filter 1365 and are blocked by red filter 1373 while red rays 1363 pass through the red filter 1373 and are blocked by the blue filter 1365, so substantially no direct sunlight passes though panels 1450 into the greenhouse during the summer months according to an embodiment of the invention.

However, as shown in FIG. 15, during winter months, when sun 1305 is now shining at lower angles and is incident at smaller angle of about 90° relative to line “A”, for example. Accordingly blue rays now 1366 traverse both upper and lower blue filters 1365 into the greenhouse and so too red rays 1363 pass through both upper and lower red filters 1373.

Inside the green house, the internal surfaces of panels 1450 facing the greenhouse interior may be coated with a selective reflective material 1460 that transmits certain wavelength into the greenhouse, but selectively reflects them internally 1465; for example, infrared (IR). In this manner heat can be internally reflected within the greenhouse during cooler nights to maintain desirable temperature levels or to reduce temperature fluctuations between day and night, according to certain non-limiting embodiments. It should be appreciated that this reflective surface is shown on only one panel 1450 for the sake of clarity and that indeed such a feature could be implemented on both panels 1450.

In certain embodiments substrate 1356 is implemented as a polymeric material for additional spectral-selective attenuation to filter UV wavelengths and reduce insect populations that use UV transmission as a directional signal. Not only does such UV filtering advantageously reduce such populations it also reduces diseases transmitted through such pests.

Other forms of selective spectral attenuation may be employed to promote plant growth, flower development, and fruit production and ripening, for example.

Embodiments having a spectral-specific attenuating regions for a single season may be replaced or reversed seasonally, either manually or via automated electro-mechanical reversing mechanisms. It should be further appreciated that embodiments having spectral-specific attenuating regions responsive to changes in incident sunlight from any one of the four seasons to the next are also included within the scope of the present invention.

An example of a reversible panel is one having a selective reflective material 1460 disposed outwardly during summer months to reflect unwanted heat. In winter, the reversible panel may be reversed so that the selective reflective material 1460 is now disposed inwardly to reflect heat into inside the greenhouse.

FIGS. 15A-15C are perspective views of spectral-specific attenuating regions depicting transmission as a function of seasonal or daily changes in light incidence, according to a non-limiting embodiment.

FIGS. 15A and 15B illustrate changes in incident angles of wavelengths 1366 or 1363, as a function of change in summer and winter sun trajectories, as denoted by arc 1306S. Sun 1305 traces out a summer daily trajectory 1306SD traversing position 1305S in FIG. 15A and a winter daily trajectory 1306WD traversing position 1305W in FIG. 15B, according to embodiments.

Specifically, spectral-specific attenuating regions 1373 and 1365 are disposed in a direction substantially parallel to the direction of daily trajectories 1306SD and 1306WD and substantially perpendicular to the direction of seasonal change 1306S of these trajectories, according to embodiments. As shown in FIG. 15A, wavelengths 1363 and 1366 emanating from sun 1305 at position 1305S in summer daily trajectory 1306SD These rays are incident at a substantially perpendicular angle to the upper attenuating surface 1370 and are attenuated by both attenuating regions 1365 or 1373 at either upper or lower attenuating surfaces, 1370 and 1372, respectively.

In contrast, FIG. 15B depicts wavelengths 1363 and 1366 emanating from sun 1305 at position 1305W in lower winter, daily trajectory 1306WD. These rays are incident on upper attenuating surface 1370 at a non-perpendicular angle and traverse some attenuating regions 1365 and 1373 of upper attenuating surface 1370 and continue at an angle of incidence associated with daily winter trajectory 1306WD and also traverse attenuating regions 1365 or 1373 of lower attenuating surface 1372, as shown.

It should be appreciated that various embodiments having attenuation region configurations in which light traverses different spectral-specific attenuating regions seasonally are included within the scope of this invention.

This configuration advantageously provides little change in attenuation as a function of daily changes in the sun's position, be it summer or winter as shown by the daily trajectories 1306SD and 1306WD; but, provides significant change in attenuation as function of changes in seasonal trajectories as depicted by arc 1306S, as noted above.

FIG. 15C depicts attenuating regions 1373 and 1365 of FIGS. 15B and 15C disposed in a direction substantially perpendicular to daily trajectory 1306D such that some wavelengths traverse both upper and lower attenuation surfaces, 1370 and 1372, respectively, while other wavelengths are attenuated, at some time of the day.

For example when the sun is disposed in position 1305A, the resulting angle of incidence causes wavelength 1366A to traverses attenuation regions 1365 of bother upper and lower attenuating surfaces 1370 and 1372. Wavelength 1363A is attenuated by attenuation regions 1365 of upper attenuating surface 1370; but, traverses attenuation regions 1373 of both upper and lower attenuation surfaces 1370 and 1372, respectively, thereby allowing these two wavelengths to pass into the greenhouse during these early daylight hours.

However, when the sun is disposed at position 1305B, the approximate zenith of its daily trajectory, wavelength 1366B traverses attenuating region 1373 of upper attenuating surface 1370; but, does not traverse attenuating region 1365 of lower attenuation surface 1372 whereas wavelength 1363B is attenuated by attenuating region 1373 of the upper attenuating surface 1370. Similarly, wavelength 1366B is attenuated by attenuating region 1365 of upper attenuating surface 1370 whereas wavelength 1363B traverses this attenuation region and is attenuated at attenuating region 1373 of lower attenuating surface 1372.

When the sun is disposed in position 1305C, at relatively low point of its trajectory in the late afternoon hours, wavelength 1363C traverses attenuation regions 1373 of both upper and lower attenuating surfaces 1370 and 1372 whereas wavelength 1366C is attenuated at attenuating region 1373 of upper attenuating surface 1370; but, traverses attenuation regions 1365 of both upper and lower attenuation surfaces 1370 and 1372 allowing these two wavelengths, 1363C and 1366C to pass into the greenhouse.

This configuration advantageously provides time-based shading in which the greatest shading occurs during hours of the most intense, direct sunlight and greatest exposure during hours of lower intensity sunlight, according to embodiments.

It should be appreciated that although depicted as sunlight incident on only one or two attenuation region at each position, sunlight is in fact incident at the same angle on all attenuation regions at the same time, while the transmission is related to the attenuation of the particular wavelength, according to non-limiting embodiments. The above examples provided descriptions of mainly daily or seasonal changes in exposure. However, it should be appreciated that in certain embodiments, attenuation regions are disposed at particular angle to the direction of the sun trajectory (which is usually between the perpendicular to the parallel to the direction of the sun trajectory) to provide both seasonal and daily attenuation, as is known to those skilled in the art.

Spectral specific attenuation may also be employed in behavior modification centers applying wavelength-specific light for time periods deemed to be therapeutic, for example.

In certain embodiments variable-transmission substrates are configured to provide directional attenuation. For example, when implemented as a sunroof of a motor vehicle, light transmission through the sunroof may be selectively directed to meet different requirements of a driver and passengers. Furthermore, when variable-transmission medium is implemented as a back window rear viewing is preserved in addition to blocking or reflecting various visible light and IR wavelengths, according to embodiments.

FIG. 15D depicts a motor vehicle 1500 fitted with a variable-transmission implemented as sunroof 1505 disposed in roof 1506. As shown, incident rays 1523 and 1524 are processed differently by sunroof 1505 in that ray 1524 directed toward the driver is attenuated while ray 1523 directed to the back seat is allowed to traverse, according to an embodiment.

As shown, vehicle 1500 is also fitted with variable transmission medium implemented as a rear window; as depicted most clearly shown in FIG. 15H. The rear window is configured to allow passage of light reflected from mirror 1507 as depicted by ray 1535 while infrared light and various wavelengths of visible light 1531 thereby reducing cabin heat and excessive light.

It should be appreciated that a motor vehicle 1500 is used as a demonstrative example of particular embodiments that also have applicability in wide variety of situations in non-automotive applications.

FIGS. 15E-15G are schematic side-views of sunroof 1505 of FIG. 15D and depict two patterned substrates 1521 and 1522 in full transmission, full attenuation, and directional transmission and attenuation states, respectively

Specifically, sunroof 1505 is implemented as two substrates 1521 and 1522 of light-transparent material separated by a variable inter-surface gap 1525 and each of substrates 1521 and 1522 have a pattern of attenuating regions 1521A and non-attenuating regions 1521B disposed on a single surface, according to an embodiment.

In operation, when substrates 1521 and 1522 are disposed such that their respective attenuating regions 1521A and 1522A are in alignment, both light rays 1523 and 1524 traverse substrates 1521 and 1522 through non-attenuating 1521B and 1522B, thereby lighting both a driver's seat and a passenger section, for example.

FIG. 15F depicts substrates 1521 and 1522 after translation in a substantially parallel manner as indicated by arrow “A” such that attenuating regions 1521A and 1522A are disposed in in non-alignment, thereby attenuating both light rays 1523 and 1524.

FIG. 15G depicts substrates 1521 and 1522 after a change in proximity to each other after substantially perpendicular translation relative to a plane defined by either of substrates 1521 and 1522 and indicated by arrow “B”. Attenuating regions 1521A and 1522A remain in a state of non-alignment after translation so that light ray 1523 traverses substrates 1521 and 1522 through non-attenuating 1521B and 1522B whereas light ray 1524 is attenuated by attenuating regions 1522A. Such a configuration advantageously provides selective transmission direction; light ray 1524 directed toward the driver is attenuated while ray 1523 directed toward the back seat passes traverses substrates 1521 and 1522, according to an embodiment.

Translation of either of substrates 1521 and 1522 is achieved through a conveyance mechanism 1509 (FIG. 15D) configured to provide either lateral or perpendicular motion of either on of substrates 1521 and 1522 or both of them, depending on embodiments. In another embodiment, conveyance mechanism 1509 is configured to change the proximity of one edge of either of substrates 1521 and 1522 while the other edge remains substantially stationary or changes in proximity to a lesser degree. In certain embodiments, the conveyer mechanism 1509 is powered by an electric motor and in another embodiment is actuated responsively to a threshold value of an output signal from either a heat or light sensor.

FIG. 15H is a schematic side-view of an embodiment of a variable-transmission medium 1536 implemented as a rear window of motor vehicle 1500 of FIG. 15D. As shown, variable-transmission medium 1536 is pivotally mounted to roof 1506 and support structure 1508 and includes a transparent substrate 1530 having two-patterned surfaces of attenuating and non-attenuating regions 1534 and 1534A, respectively. In a certain embodiment, attenuating regions 1534 are implemented as infrared (IR) reflective material to facilitate reflection of IR to reduce cabin heating from incident sunlight. In other embodiments, attenuating regions 1534 are formed from materials that in addition to being IR reflective are also reflective of or absorb other wavelengths associated with colors of the visible spectrum to further reduce cabin heating.

As shown, incident light 1531 of the above-noted wavelengths are selectively reflected as indicated by ray 1532. Furthermore, reflected light 1535 from rear view mirror 1507 traverses substrate 1530 through non-attenuating regions 1534A, thereby providing substantially unobstructed view through the back window while minimizing undesirable heating from incident sunlight.

In a certain embodiment, an angle of incidence of both incident sunlight and light reflected from rear view mirror 1507 may be modulated by moving substrate along track 1537 as depicted by arrow “C”; however, it should be appreciated that various mechanisms (providing such functionality are included within the scope of the present invention.

As noted above, such adjustments may be executed by an electrical motor that may be actuated responsively to light or heat sensor feedback. It should be further noted that in a certain embodiment, variable-transmission medium 1536 is fixedly mounted.

### Fabrication

Different techniques may be employed to apply patterned attenuating regions to light transmissive substrates according to various embodiments of the present invention. Advantages of the present invention include the ability to fabricate components using currently-available manufacturing methods. For example, patterns of attenuating ink on a transparent substrate can be applied using processes including, but not limited to: flexographic printing; screen printing; inkjet printing; inkjet UV-cured printing; and inkjet for ceramic ink printing. For printing very thin attenuating linear regions (such as in the range of microns), an inkjet printing mechanism can be used. Inkjet printing heads can move as customary, or, to increase productivity, can be arranged in a row perpendicular to the movement of the transparent substrate. Where a very high density of lines in a given area of linear attenuating regions is required, but which is higher than conventional inkjet head positioning allows, a cascading arrangement of inkjet heads may be used, where the inkjet heads are placed in cascading perpendicular rows, each inkjet head offset a very short distance away from the previous linear region generated by the inkjet in front of it. Other fabrication methods include lamination, such as pressing a laminate or polymer material of the required optical properties onto a transparent layer using laminating equipment; vacuum deposition, vacuum sputtering, painting, and coating.

FIG. 16 schematically shows an example of producing a light attenuating pattern layer of ink on a transparent substrate using flexographic printing.

In one embodiment, attenuating lines 14 are printed by a flexographic printer 40 on a transparent substrate 38 as shown. The flexographic printing or other offset printing may provide a convenient, efficient, and low cost production means to implement embodiments of the invention.

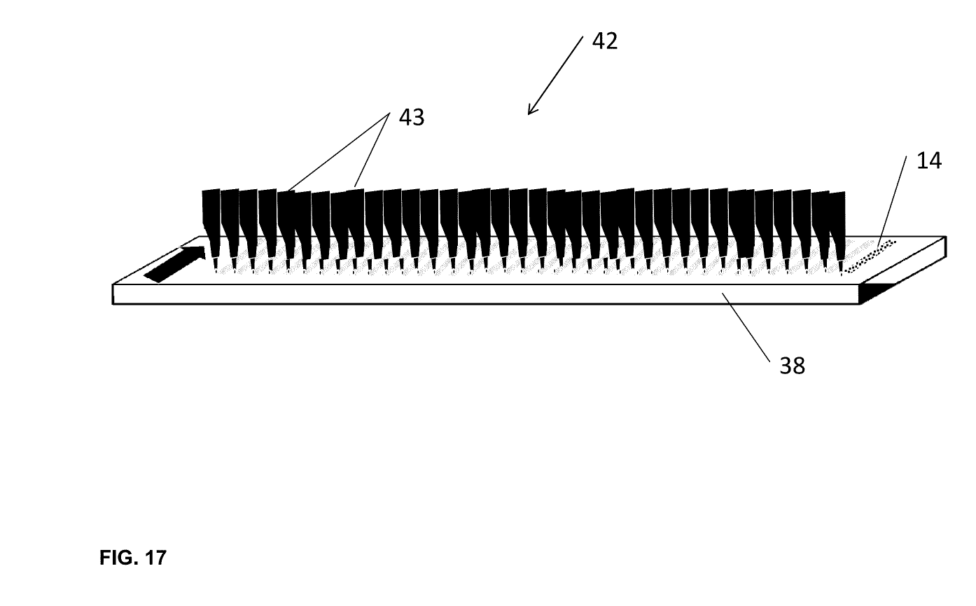

FIG. 17 schematically shows an example of producing a light attenuating pattern layer of opaque ink on a transparent substrate using inkjet printing.

In the illustrated embodiment, when very thin opaque lines 14 are desired (in the microns level) an inkjet printing mechanism can be deployed. The inkjet printing heads 43 can move as customary, or, to increase productivity, can be arranged in a row 42 oriented perpendicular to the movement of the transparent substrate 38.

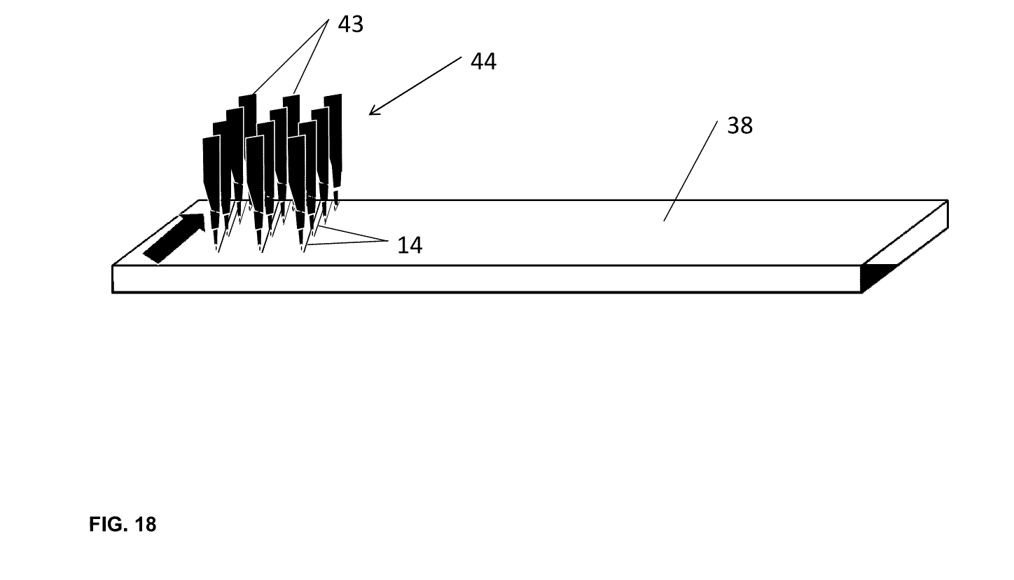

FIG. 18 schematically shows an example of producing a layer of opaque ink 14 on a transparent substrate 38 using inkjet printing, where the printing heads are also aligned behind each other to allow for narrower gap between the lines. In an embodiment, when a very high optical density of lines is required, which may be higher than the inkjet head positioning may allow, a cascading arrangement 44 of inkjet heads 43 may be used. Inkjet heads are placed in cascading perpendicular rows, behind each of the printing heads 43, each inkjet printing head 43 printing a very short distance away from the previous line, which was generated by the inkjet in front of it. This may increase the resolution, or the number of lines printed.

Other methods may be used to deposit a material on a transparent material or substrate so as to form a nontransparent area. Such methods may include, for example, sputtering and vacuum deposition (e.g. of a metal or metallic compound). Such a method may be controlled so as to deposit a predetermined thickness of material on the substrate.

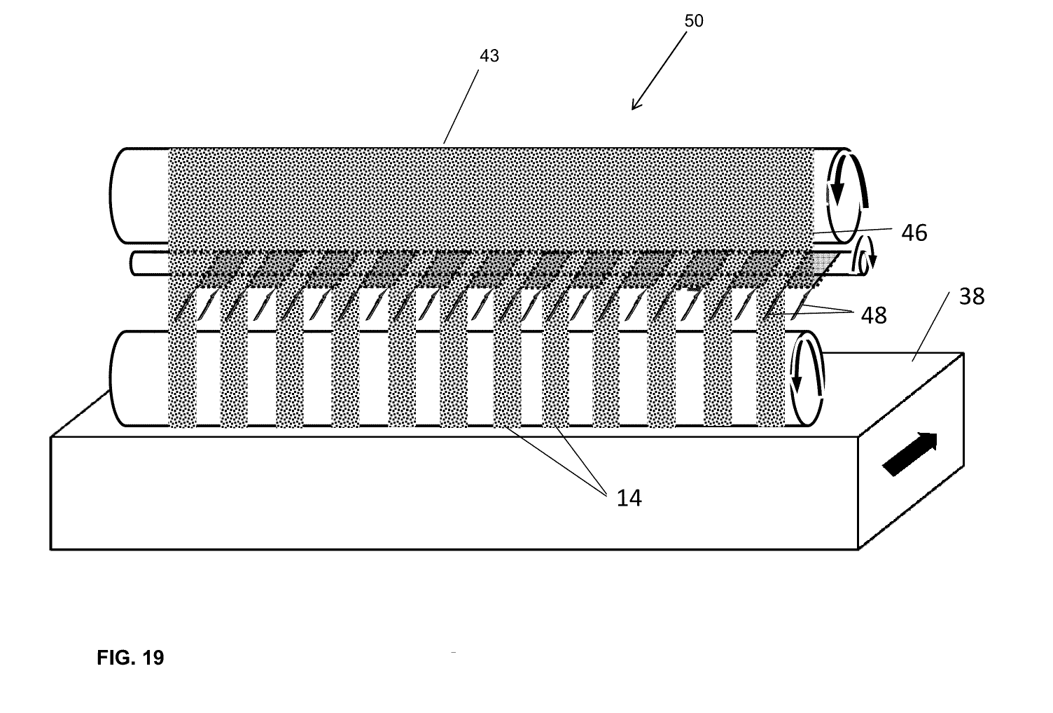

FIG. 19 shows printing (depositing) laminated optically modifying material on a transparent pane. Another method to deposit optically modifying areas on a substrate, or panel, is by pressing a laminate 46 or polymer material having the required optical properties onto the substrate 38 using lamination device 50. Coated strips of laminate 46 may be separated from uncoated strips using a series of blades 48.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A variable transmission medium comprising:
a plurality of patterned surfaces of attenuating regions and non-attenuating regions on light-transmissive material, each of the patterned surfaces separated by an inter-surface gap; and
a rotational conveyance mechanism configured to rotate the patterned surfaces so as to cause light attenuation as a function of rotation angle.

2. The variable transmission medium of claim 1, wherein the light-transmissive material is implemented as a single substrate.

3. The variable transmission medium of claim 1, wherein the light-transmissive material is constructed from a substance selected from the group consisting of glass, polymer, resin, and acrylic.

4. The variable transmission medium of claim 1, wherein the light-transmissive material is implemented with an arcuate surface geometry.

5. The variable transmission medium of claim 1, wherein the light-transmissive material is implemented as a plurality of substrates.

6. The variable transmission medium of claim 5, wherein each of the substrates at least partially encloses a cavity containing a transparent material selected from the group consisting of glass, polymer, resin, acrylic, glue, laminate, liquid, and gas.

7. The variable transmission medium of claim 1 wherein the inter-surface gap progressively increases along a length of the light-transmissive material.

8. The variable transmission medium of claim 1, wherein one or more of the attenuating regions is implemented as geometrical shape bound by at least one curved line.

9. The variable transmission medium of claim 1, wherein each the plurality of patterns differ from each other.

10. The variable transmission medium of claim 1, wherein spacing of the attenuating regions progressively changes along a length of the light-transmissive material.

11. The variable transmission medium of claim 1, wherein at least a portion of the attenuating region is formed from a plurality of attenuating substances.

12. The variable transmission medium of claim 1, wherein the attenuating regions at least partially reflect IR, UV, or visible frequencies of the electromagnetic spectrum.

13. The variable transmission medium of claim 1, wherein the rotational conveyance mechanism pivotally mounted in a building or in a motor vehicle.

14. The variable transmission medium of claims 13, wherein the rotational conveyance mechanism includes a self-powered, rotational-conveyance mechanism.

15. The variable transmission medium of claim 14, wherein the self-powered, rotational-conveyance mechanism is actuated by a threshold brightness level.

16. The variable transmission medium of claim 1, wherein the rotational conveyance mechanism is pivotally mounted to a motorcycle helmet or to a cap.

17. A variable-transmission, building visor, comprising:
a plurality of patterned surfaces of attenuating regions and non-attenuating regions on light-transmissive material, wherein the light-transmissive material is mounted to a non-moveable structure in substantially parallel manner such that the attenuation regions are disposed in a direction substantially parallel to daily sun trajectory and substantially perpendicular to a direction of seasonal change of the sun trajectory or the attenuation regions are disposed in a direction substantially perpendicular to the daily sun trajectory and substantially parallel to the direction of seasonal change of the sun trajectory.

18. The variable transmission, building visor of claim 17, wherein the attenuation regions are implemented as spectrally-specific attenuation regions.

19. A variable transmission medium comprising:
a plurality of patterned surfaces of attenuating regions and non-attenuating regions on light-transmissive material, each of the patterned surfaces separated by an inter-surface gap; and
a conveyance mechanism configured to change proximity of the patterned surfaces to each other such that light incident at a first angle traverses the non-attenuating regions and light incident at a second angle is attenuated by the attenuating regions.

20. The variable transmission medium of claims 19, wherein the conveyance mechanism includes a self-powered, conveyance mechanism.

21. The variable transmission medium of claim 20, wherein the self-powered, conveyance mechanism is actuated by a threshold brightness level.

22. A variable-transmission display-device-cover comprising:
a plurality of patterned surfaces of attenuating regions and non-attenuating regions on light-transmissive material, each of the patterned surfaces separated by an inter-surface gap; and
a connector holding the light-transmissive material to a display device so as to cause light attenuation as a function of viewing angle.

23. A viewing arrangement comprising:
a plurality of patterned surfaces of attenuating regions and non-attenuating regions on light-transmissive material, each of the patterned surfaces separated by an inter-surface gap; and
a viewing device configured to reflect light passing through the non-attenuating regions.

24. The viewing arrangement of claim 25, wherein the light-transmissive material is implemented with an arcuate surface geometry.

27. The viewing arrangement of claim 26, wherein the attenuating regions are implemented from material reflecting light.
